(19) United States
(12) Patent Application Publication
(10) Pub. No.: US 2019/0043239 A1
(43) Pub. Date: Feb. 7, 2019

(54) METHODS, SYSTEMS, ARTICLES OF MANUFACTURE AND APPARATUS FOR GENERATING A RESPONSE FOR AN AVATAR

(71) Applicant: Intel Corporation, Santa Clara, CA (US)

(72) Inventors: Manan Goel, Portland, OR (US); Matthew Pickett, San Francisco, CA (US); Michael Rosen, San Jose, CA (US); Dipika Jain, San Jose, CA (US); Adelle Lin, Hillsboro, OR (US)

(21) Appl. No.: 16/146,710

(22) Filed: Sep. 28, 2018

Related U.S. Application Data
(60) Provisional application No. 62/614,477, filed on Jan. 7, 2018.

(51) Int. Cl. G06T 13/20; G10L 19/00; G06T 13/40; G06N 99/00

(52) U.S. Cl. CPC G06T 13/205; G06N 99/005; G06T 13/40; G10L 19/00

(57) ABSTRACT

Methods, apparatus, systems and articles of manufacture are disclosed for generating an audiovisual response for an avatar. An example method includes converting a first digital signal representative of first audio including a first tone, the first digital signal incompatible with a model, to a plurality of binary values representative of a first characteristic value of the first tone, the plurality of binary values compatible with the model, selecting one of a plurality of characteristic values associated with a plurality of probability values output from the model, the probability values incompatible for output via a second digital signal representative of second audio, as a second characteristic value associated with a second tone to be included in the second audio, the second characteristic value compatible for output via the second digital signal, and controlling the avatar to output an audiovisual response based on the second digital signal and a first response type.

### RELATED APPLICATION

This patent claims the benefit of U.S. Provisional Patent Application No. 62/614,477, filed Jan. 7, 2018, entitled “Methods, Systems, Articles of Manufacture and Apparatus to Generate Emotional Response for a Virtual Avatar.” U.S. Provisional Patent Application No. 62/614,477 is hereby incorporated by reference herein in its entirety.

### FIELD OF THE DISCLOSURE

This disclosure relates generally to avatars, and, more particularly, to methods, systems, articles of manufacture and apparatus for generating a response for an avatar.

### BACKGROUND

In recent years, artificial intelligence deep learning techniques have improved processing and learning efforts associated with large amounts of data. Neural network (NN) techniques facilitate training of input data (e.g., dense matrix operations, tensor processing, etc.) such that the resulting trained networks can be applied during runtime tasks.

### BRIEF DESCRIPTION OF THE DRAWINGS

FIG. 1 is an illustration of an example environment of use for an example avatar response generator constructed in accordance with teachings of this disclosure to generate a response for an avatar.

FIG. 2 is a block diagram of the example avatar response generator of FIG. 1 to generate a response for an avatar in accordance with teachings of this disclosure.

FIG. 3 is a block diagram of an example machine learning engine of the example avatar response generator of FIGS. 1 and 2.

FIG. 4A is an example data flow including a musical instrument data interface (MIDI) input to an avatar response model and a corresponding MIDI output of the avatar response model.

FIG. 4B is an example data flow including a probability distribution that is a representation of the MIDI input to the avatar response model and a probability distribution that is a representation of the corresponding MIDI output of the avatar response model.

FIG. 5 is an example user interface generated by the example avatar response generator of FIGS. 1 and/or 2.

FIGS. 6-11 are flowcharts representative of example machine readable instructions which may be executed to implement the example avatar response generator of FIGS. 1 and/or 2.

FIG. 12 is a block diagram of an example processing platform structured to execute the instructions of FIGS. 6-11 to implement the example avatar response generator of FIGS. 1 and 2 to generate a response for an avatar.

The figures are not to scale. Instead, the thickness of the layers or regions may be enlarged in the drawings. In general, the same reference numbers will be used throughout the drawing(s) and accompanying written description to refer to the same or like parts.

### DETAILED DESCRIPTION

As used herein, neural networks (NNs) and deep networks refer to machine learning techniques to process input data. Typically, NNs include one or more layers between an input layer and an output layer (sometimes referred to as “hidden layers”) that process the input data in an effort to converge on one or more results (e.g., determining an output result of a cat when input data includes an image of a cat). A typical deep NN includes any number of layers of operation in which each layer performs complex operations (e.g., large scale convolutions). Each layer of a NN includes one or more operations between operands, such as matrix multiplication operations, convolution operations, etc.

As used herein, a “recursive neural network” (RNN) (sometimes referred to as a “recurrent neural network”) is a type of neural network having long short-term memory (LSTM) units or blocks as building units for layers of the RNN. An RNN having one or more LSTM units is sometimes referred to herein as an LSTM network. In some examples, the LSTM network classifies, processes and/or otherwise predicts time series information in connection with time lags of data having an unknown and/or otherwise irregular duration between events.

As used herein, a “Musical Instrument Digital Interface (MIDI) File” is a data file representative of an audio track including one or more MIDI messages. The messages indicate an event (e.g., tone start, tone hold, tone end, etc.) included in the audio track and one or more characteristics (e.g., pitch, velocity (e.g., volume), duration, etc.) of a tone. In some examples, a plurality of MIDI messages constitute a sequence of tones (e.g., notes). In some examples, data included in the MIDI file includes one or more digital data packets (e.g., the MIDI messages). Some such MIDI files require less storage space and less processing resources (e.g., the processing associated with modification of the audio track associated with the MIDI file) than other audio types (e.g., .wav, .mp3, etc.).

Examples disclosed herein modify and/or otherwise control (e.g., generate) one or more audio and/or visual characteristics of an avatar based on a musical input (e.g., input from a musical instrument digital interface (MIDI) protocol/interface) associated with at least one of stored musical data and/or a live musical presentation passed through a model trained utilizing machine learning techniques. However, in some examples, the format of the MIDI input is not compatible with the trained model. Examples disclosed herein convert the MIDI input into a plurality of binary values that are compatible with the trained model.

In some examples, the audio and/or visual characteristics of the avatar are generated in a manner consistent with one or more musical styles, tempos and/or emotions of the music and/or musician. In some examples, a virtual avatar is controlled to respond to the music input by enacting an action of playing a musical phrase (e.g., a sequence of tones played in a defined time window) on an instrument (e.g., a guitar) and/or enacting a corresponding emotion (e.g., the emotion corresponding to a motion profile) as a response to the music input.

In some examples, the aforementioned model is generated utilizing machine learning techniques in connection with a large amount of musical data. Between one or more databases, thousands of hours of musical data are available to be analyzed. Additionally, musical data can be generated in real time by an individual and/or group of individuals with musical instruments. Using the stored musical data or dynamically generated musical data, machine learning (e.g., deep learning) techniques can be used to generate an audio (e.g., musical) response and/or a visual (e.g., emotional, movement, etc.) response to a portion of the stored data. However, in some examples, the response generated by the machine learning techniques includes a plurality of probability values that are not compatible for output as an audio (e.g., MIDI output) and/or visual response. Examples disclosed herein include converting the plurality of probability values to a format compatible for output as a digital signal (e.g., such as a MIDI file). Once converted, the audio and visual response can be applied to a digital avatar (e.g., an avatar of a musician) for display in real time.

In some examples, a biomechanical model simulates human movements to create the avatar movement(s) in a manner that displays the enacted emotion, in which the model includes details associated with particular musical styles, particular tempos and/or the particular emotion of the musician. In some examples disclosed herein, artificial intelligence (AI), virtual reality (VR) and/or virtual three-dimensional (3D) environments employ virtual avatars to display and/or otherwise convey emotional characteristics to one or more virtual avatars in connection with musical input. In some examples, AI and rule-based techniques dictate virtual avatar animation behavior in a manner that displays more realistic human behavior.

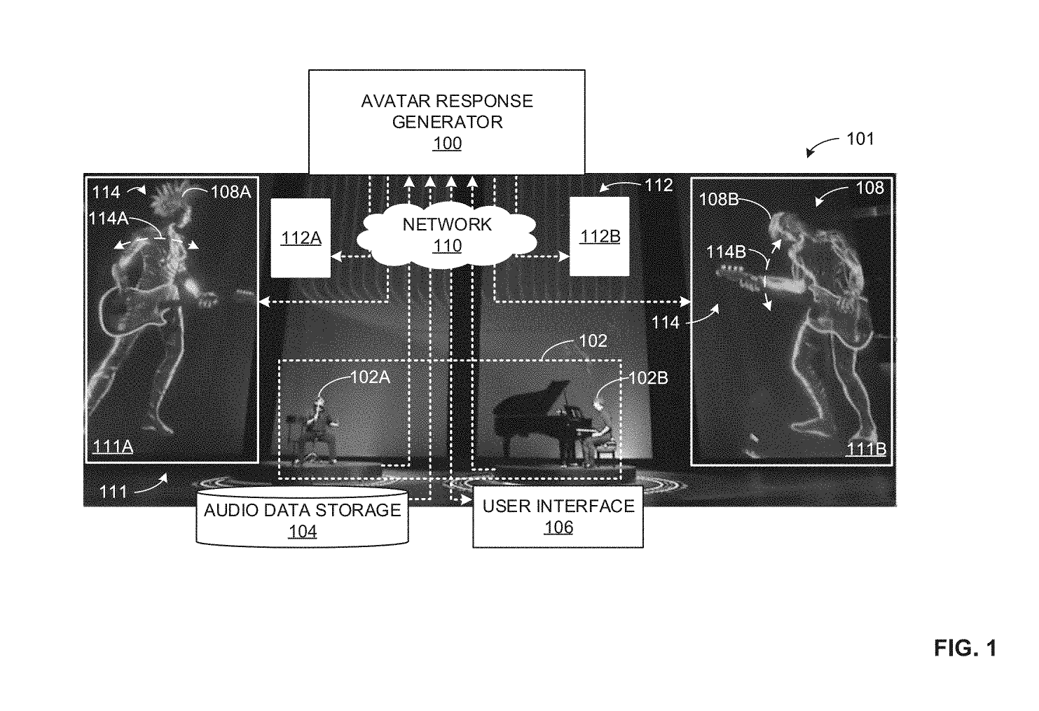

FIG. 1 illustrates an example avatar response generator 100 operating in an example avatar environment 101. As illustrated in FIG. 1, the example avatar response generator 100 receives input data from one or more example musicians 102 (such as an example first musician 102A and/or an example second musicians 102B), an example audio data storage 104, an example user interface 106, and one or more example avatars 108 (such as an example first avatar 108A and/or an example second avatar 108B). Each of the aforementioned in communication with the example avatar response generator 100 via an example network 110). In some examples, the avatar response generator 100 distributes outputs to at least one of the example user interface 106, example displays 111 (such as an example first display 111A and/or an example second display 111B), and example audio emitters 112 (such as an example first audio emitter 112A) and/or an example second audio emitter 112B. In some examples, the displays 111 and the audio emitters 112 output visual and/or audio characteristics of the avatars 108 via the example network 110. In general, the avatar response generator 100 retrieves audio data from at least one of the musicians 102 and/or the audio data storage 104 (the audio source selected based upon an input to the user interface 106) and invokes a machine learning model trained by the avatar response generator 100. In such examples, the machine learning model generates an audio and/or visual response to be applied to at least one of the avatars 108, the visual response output by way of the displays 111 and the audio response output by way of the audio emitters 112.

The example musicians 102, as illustrated in FIG. 1 and described in connection with the example avatar environment 101, are playing instruments (e.g., generating a musical instrument digital interface (MIDI) track) . For instance, the first musician 102A is playing a MIDI based drum set, and the second musician 102B is playing a piano. In some examples, the instrument is a MIDI instrument, the output of which is a MIDI file. In other examples, the instrument is not a MIDI instrument and the output of the instrument is further passed to a MIDI converter to generate the MIDI file.

In some examples, one or more of the musicians 102 generate a MIDI track to be used in a model. The model generates a second different MIDI track to be rendered (e.g., as used herein, “rendering” refers to at least one of rendering of an audio file, rendering a video file, rendering both of audio file and a video file, etc.) by one of the avatars 108. In such examples, the MIDI track output by one of the avatars 108 is a modeled response to the MIDI track generated by one of the musicians 102, the response rendered following the input MIDI track. For instance, if the example first musician 102A plays (e.g., executes) a series of notes (e.g., a “riff,” a “musical phrase,” etc.) on an instrument, the model processes the first series of notes to generate an augmented (e.g., second) series of notes as a second MIDI track having different characteristics. In some examples, the model generates the second MIDI track to include a second series of notes for an alternate instrument, in which the notes are generated at an alternate octave when compared to the first series of notes. Such second MIDI track(s) may be time delayed to render the impression of one of the avatars 108 reacting to the previous musician's “riff” or “musical phrase.” In other examples, one or more of the musicians 102 generate a MIDI track output alongside the second different MIDI track rendered by one of the avatars 108. In either example, the MIDI track(s) generated by the musicians 102 are auditorily output by at least one of the audio emitters 112.

The example audio data storage 104, included in or otherwise implemented by the example avatar response generator 100, stores one or more audio tracks. In some examples, the audio tracks are stored in association with a genre (e.g., classical, jazz, rock, etc.) of the audio track. In some examples, the audio tracks are stored as audio data (e.g., .mp3, .WAV, .AAC, etc.). In such examples, the audio data is converted to the MIDI format prior to output to the avatar response generator 100 via the network 110. In some examples, the audio tracks are stored as MIDI files in the audio data storage 104 and are directly passed to the avatar response generator 100 via the network 110.

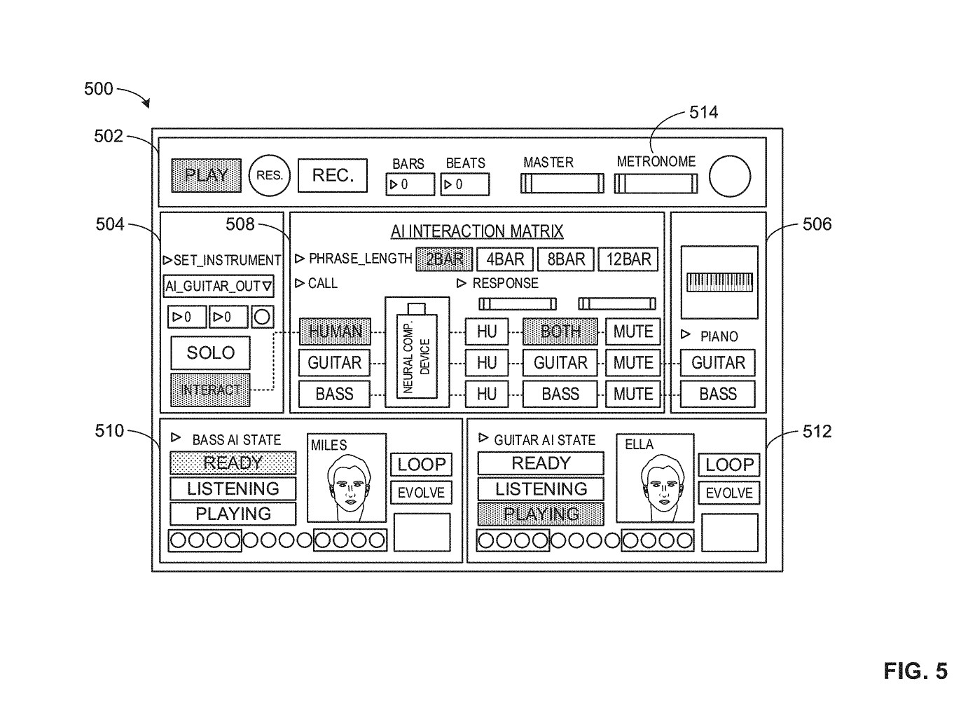

The example user interface 106 of the example avatar environment 101 can be interacted with by a user (e.g., for example, one of the musicians 102A, 102B) to control and/or view an output of the avatar response generator 100. For example, one of the musicians 102 can define an input to the avatar response generator 100, and/or define an output of the avatar response generator 100 via the user interface 106. An example of the user interface 106 is described further in connection with FIG. 5.

The example avatars 108 of the example avatar environment 101 are digital representations of musicians. In some examples, the avatar(s) 108A, 108B include a graphical representation of a musician in addition to an audio representation of the instrument played by the musician. In such examples, one or more characteristics of the graphical representation (e.g., positioning of the avatars 108, motion of the avatars 108, etc.) of the avatars 108 can correspond to one or more characteristics of the audio representation of the instrument played by the musician. Thus, in one example of operation of the example second avatar 108B, the avatar response generator 100 determines the characteristics of the audio representation of the instrument played corresponds to a high tempo solo and commands the graphical representation of the avatar 108B to hunch over or otherwise move in tempo with the high tempo solo.

In the illustrated example of FIG. 1, the graphical portion(s) of the avatars 108 are output via the displays 111. The displays 111 may be, but are not limited to, LCD screens, LED screens, OLED screens, projection screens, any display capable of displaying video, etc. Additionally, in the illustrated example of FIG. 1, the audio portion(s) of the avatars 108 are output via the audio emitters 112. The audio emitters 112 may be, but are not limited to, speakers, a stereo system, a sound system, ear buds, headphones, etc.

In the illustrated example of FIG. 1, motion profiles 114 such as an example first motion profile 114A and/or an example second motion profile 114B are associated with the example first avatar 108A and the example second avatar 108B, respectively, and generated via movement instructions generated by the example avatar response generator 100. The example first motion profile 114A illustrates a horizontal rocking (e.g., swaying) of the upper chest of the example first avatar 108A and follows a trajectory illustrated by example horizontal dashed lines near label 114A. Similarly, the example second motion profile 114B illustrates a vertical rocking (e.g., swaying) of the head of the example second avatar 108B, which follows a trajectory illustrated by example vertical dashed lines near label 114B. In some examples, the trajectories of the motion profiles 114 are further associated with one or more characteristics (e.g., characteristic values) of the audio output of the avatars 108, respectively, such as tempo, pitch variation, pitch duration, etc. In some examples, the trajectories of the motion profiles 114 can instead be based on a feature of the audio output of the avatars 108 such as a style and/or emotion of the music, the style and emotion correlated to at least one of the tempo, pitch variation, pitch duration, etc. In the illustrated example of FIG. 1, the horizontal swaying of the first avatar 108A along the first motion profile 114A may correspond to a relaxed style of music (e.g., smooth jazz, classical, etc.), while the vertical rocking of the second avatar 108B along the second motion profile 114B may correspond to an energetic style of music (e.g., rock, heavy metal, etc.).

In the example avatar environment 101, one or more of the avatar response generator 100, the example musicians 102, the example audio data storage 104, the example user interface 106, the example displays 111, and/or the example audio emitters 112, are communicatively connected to one another via the example network 110. For example, the network 110 of the illustrated example of FIG. 1 is the Internet. However, the network 110 may be implemented using any suitable wired and/or wireless network(s) including, for example, one or more data buses, one or more Local Area Networks (LANs), one or more wireless LANs, one or more cellular networks, one or more private networks, one or more public networks, etc. The example network 110 enables the example avatar response generator 100 to be in communication with at least one of the example musicians 102, the example audio data storage 104, the example user interface 106, the example displays 111, and/or the example audio emitters 112. As used herein, the phrase “in communication,” including variances thereof, encompasses direct communication and/or indirect communication through one or more intermediary components and does not require direct physical (e.g., wired) communication and/or constant communication, but rather includes selective communication at periodic, scheduled, or aperiodic intervals, as well as one-time events.

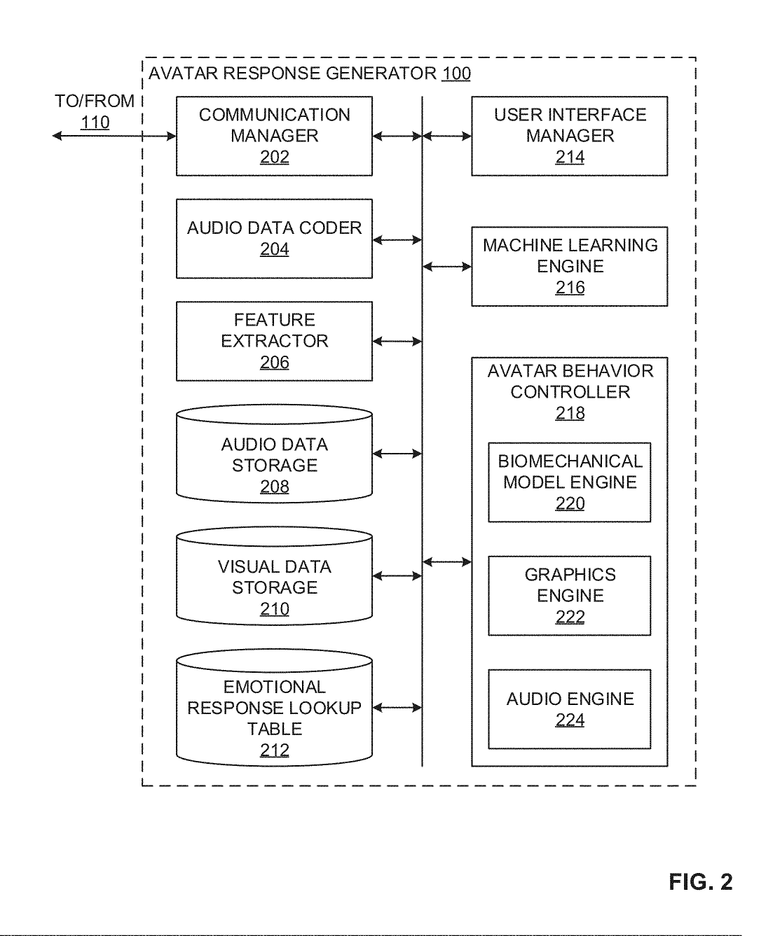

FIG. 2 is block diagram of an example implementation of the example avatar response generator 100 of FIG. 1. In some examples, the avatar response generator 100 generates at least one of an audio and/or graphical response of an avatar (the graphical response output via the displays 111 and the audio response output via the audio emitters 112) corresponding to a musical (e.g., MIDI) input to a machine learning trained model. The example avatar response generator 100 includes at least one of an example communication manager 202, an example audio data coder 204, an example feature extractor 206, an example audio data storage 208, an example visual data storage 210, an example emotional response lookup table 212, an example user interface manager 214, an example machine learning engine 216, and an example avatar behavior controller 218 which can, in some examples, further include an example biomechanical model engine 220, an example graphics engine 222, and an example audio engine 224.

The example communication manager 202 of FIG. 2 is capable of at least one of transferring data to and receiving data from at least one of the musicians 102, the audio data storage 104, the user interface 106, the displays 111, and/or the audio emitters 112 via the network 110 (e.g., structures external to the avatar response generator 100). Additionally or alternatively, the example communication manager 202 distributes data received from external entities to at least one of the example audio data coder 204, the example feature extractor 206, the example audio data storage 208, the visual data storage 210, the emotional response lookup table 212, the example user interface manager 214, the example machine learning engine 216, and/or the example avatar behavior controller 218 (e.g., structures internal to the avatar response generator 100). Additionally or alternatively, the example communication manager 202 distributes data generated by structures internal to the example avatar response generator 100 to structures external to the example avatar response generator 100.

In some examples, the communication manager 202 can be implemented by any type of interface standards, such as an Ethernet interface (wired and/or wireless), a universal serial bus (USB), and/or a PCI express interface. Further, the interface standard of the example communication manager 202 is to at least one of match the interface of the network 110 or be converted to match the interface and/or standard of the network 110.

The example audio data coder 204 of FIG. 2 coverts a received MIDI file into a format that can be processed by a machine learning model. In some examples, the machine learning model requires a two dimensional array of values processable by machine learning techniques and, as such, the MIDI file format is incompatible with the machine learning model. Similarly, output data from machine learning models (e.g., a plurality of probability values, etc.) is in a format incompatible for output via a MIDI file and/or incapable of generating controls for one or more avatar behaviors (e.g., audio and/or visual responses of one of the example avatars 108). As such, the example audio data coder 204 converts a one and/or two dimensional array of values from the model into a MIDI file. Thus, the example audio data coder 204 facilitates communication between one or more inputs and/or outputs of MIDI data (e.g., the musicians 102, the audio data storages 104, 208, the audio emitters 112, etc.) and the machine learning engine 216.

In such examples, to convert a MIDI file to a two dimensional array, the example audio data coder 204 initializes an empty two dimensional array. In some examples, a quantity of columns in the initialized array is equal to a number of MIDI messages included in the MIDI file. In such examples, the audio data coder 204 retrieves a first unanalyzed MIDI message from the MIDI file. In some examples, the MIDI message is associated with at least one of a start, a hold, and/or an end of a MIDI tone. Utilizing the retrieved MIDI tone, the audio data coder 204 extracts at least one of pitch, channel, or velocity (e.g., volume) data (e.g., characteristics of the MIDI tone) from the MIDI message. In some examples, the pitch, channel, and velocity values are stored as at least one of a numeric value (e.g., a characteristic value corresponding to a value between 0-127, each value corresponding to a distinct note and octave, a distinct audio channel, or distinct velocity (e.g., volume) level) or a hexadecimal value.

In response to extracting a value corresponding to a characteristic from the MIDI message, the extracted characteristic (e.g., at least one of pitch, channel, velocity, etc. data corresponding to the MIDI tone) is converted utilizing a one hot coding scheme. As used herein, a “one hot coding” (OHC) scheme is a technique where a one dimensional array of values includes a plurality of binary values including a single binary “1” value (e.g., a one value bit), the remaining values corresponding to binary “0” values (e.g., zero value bits). To convert the characteristic using one hot encoding, the example audio data coder 204 places the “1” value in the one dimensional array of values at a location (e.g., an index) corresponding to the numeric value of the characteristic. Thus, for example, if the numeric value corresponding to a pitch of the MIDI tone is equal to 7 (e.g., G in the 0th octave), the OHC scheme will generate a one dimensional array with a “1” in the 7^{th} position of the array and zeroes in the remaining positions.

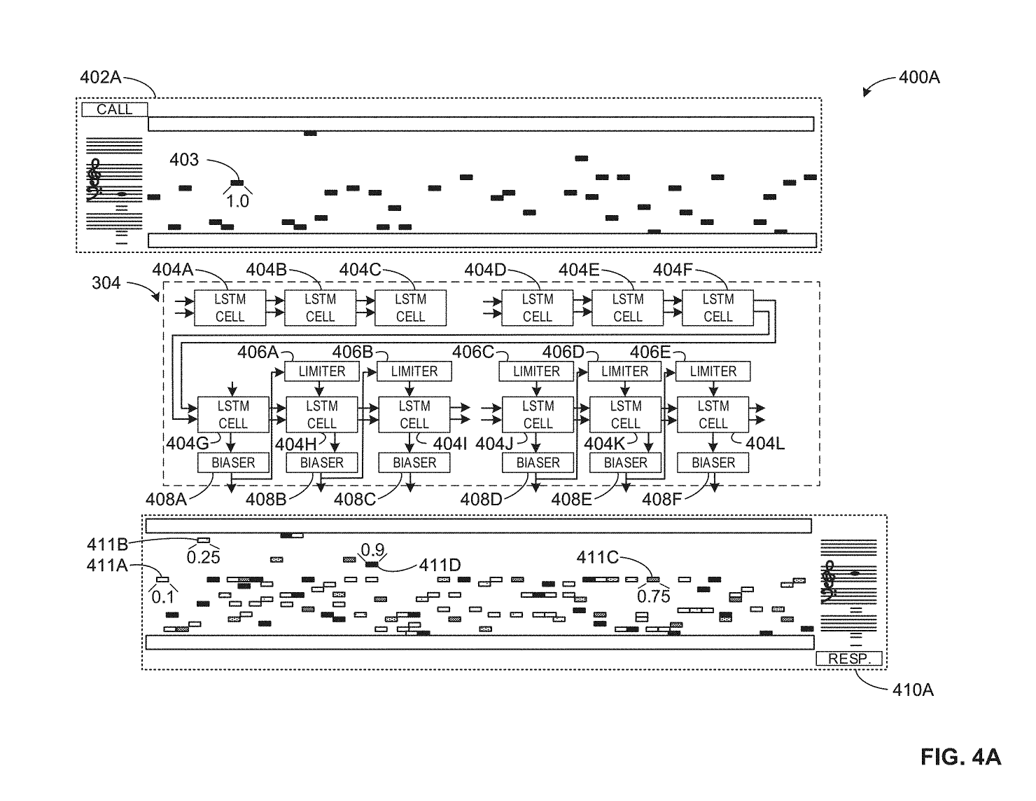

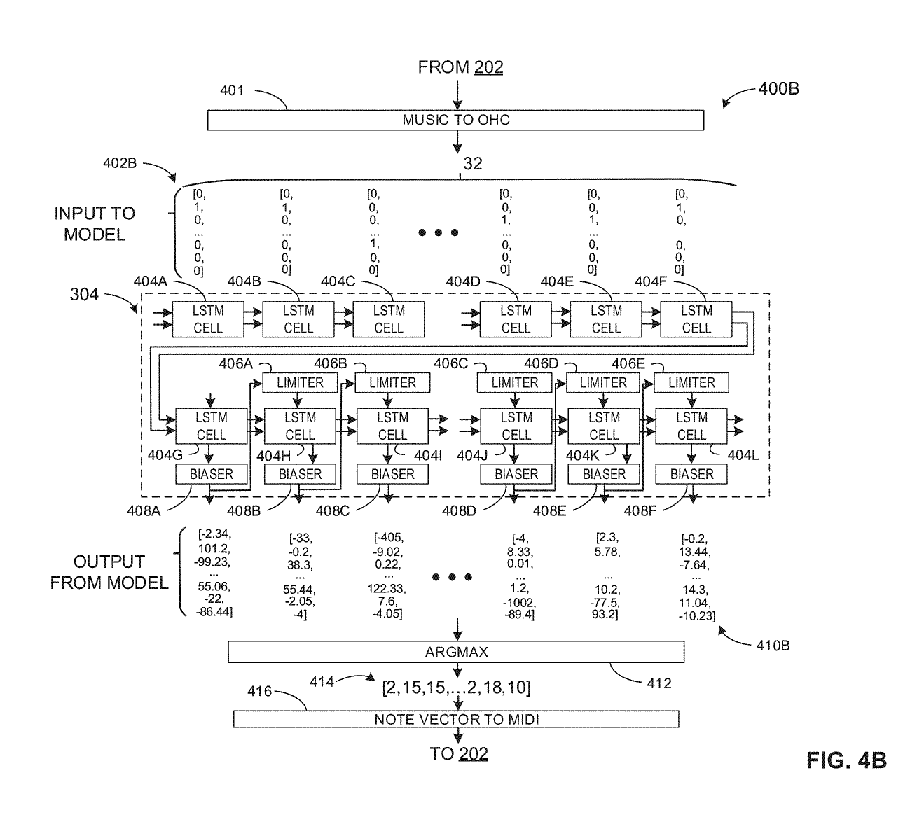

In such examples, the audio data coder 204 inserts the one dimensional array generated into a first unused column of the two dimensional array. This process is repeated until each MIDI message included in the MIDI file is processed and is represented by a corresponding column in the two dimensional array. An example of the two dimensional array is illustrated in connection with FIG. 4B, and discussed in further detail below.

In some examples, to convert a two dimensional array of probability values into a MIDI file, the example audio data coder 204 retrieves a two dimensional array of probability values from the machine learning engine 216 (e.g., an example of the two dimensional array of probability values is illustrated in connection with FIG. 4B). In response to the retrieval of the array, the audio data coder 204 determines the largest probability associated with the first unanalyzed column of the two dimensional array. For example, if the first unanalyzed column of the array includes [85.4, 23.8, −4.5, 6.7, 104.6, 98.4], the audio data coder 204 determines that 104.6 is the largest data in the column. In such examples, the audio data coder 204 further determines the index (e.g., position) of the largest probability value associated with the first unanalyzed column. Using the example above wherein 104.6 is the largest value, the largest probability value is in the 5^{th} index/position of the column and, thus, the 5^{th} index (in some examples corresponding to a value of 5 in a MIDI message) is associated with a tone to be included in the MIDI file.

The example audio data coder 204 of FIG. 2 converts the index value into a MIDI characteristic. In some examples, this includes a direct translation of the index value (e.g., 5^{th} index value, in the given example) to a MIDI value (e.g., a value of 5 (corresponding to, for pitch, an F in the 0^{th} octave), in the given example). In other examples, the MIDI value can be determined based on a mathematical correlation of the index value to the MIDI value.

In either case, the example audio data coder 204 generates a MIDI message based on the MIDI value. In some examples, generating a MIDI message further includes determining whether the characteristic is associated with at least one of a start of a tone, a hold tone, an end of a tone, etc. and generating the MIDI message denoting as such. This process is repeated for each column in the two dimensional array of probability values. In response to all columns of the two dimensional array having been analyzed, the example audio data coder 204 can output a MIDI file including the one or more generated MIDI messages.

The example feature extractor 206 of FIG. 2 retrieves the output of the example machine learning engine 216 and/or the example audio data coder 204 as (musical) note sequences and extracts one or more features contained therein. Features, in some examples, are associated with one or more characteristics (e.g., tempo, note type, octave, note duration, pitch, velocity (e.g., volume), etc.) of the one or more notes (e.g., tones) included in the note sequence. For example, the feature can be associated with an average velocity of notes included in the note sequence. In other examples, the feature can be associated with an average deviation of the pitch of the notes included in the note sequence. In some examples, the feature extractor 206 distributes the features to the example biomechanical model engine 220 and/or graphics engine 222, such as the example Unity® graphics engine, included in the avatar behavior controller 218. In some examples, the feature extractor 206 derives one or more different emotions (e.g., response types) based on the identified and/or otherwise extracted features by querying the example emotion response lookup table 212. Example emotions include, but are not limited to harmony responses, aggression responses, tense responses, and playful responses. Such emotional factors are applied as additional input to the example biomechanical model engine 220 and/or graphics engine 222, such as the example Unity® graphics engine, included in the avatar behavior controller 218.

The example audio data storage 208 of FIG. 2 stores one or more audio tracks. In some examples, the audio tracks are stored in association with a genre (e.g., classical, jazz, rock, etc.) of the audio track. In some examples, the audio tracks are stored as audio data (e.g., .mp3, .WAV, .AAC, etc.). In such examples, the audio data is converted to the MIDI format prior to processing by to the avatar response generator 100. In some examples, the audio tracks are stored as MIDI files in the audio data storage 104.

The example visual data storage 210 of FIG. 2 stores one of more characteristics of the visual/graphical representation of the example avatars 108. For example, the visual data storage 210 can include a static three dimensional (3D) rendering of at least one of the avatars 108. Additionally, the example visual data storage 210 can include static 3D renderings of other avatars and/or features of other avatars such that the visual appearance of the avatars 108 can be modified or even swapped. Additionally or alternatively, the example visual data storage 210 can also store one or more biomechanical characteristics of the avatars 108 to be utilized by the example biomechanical model engine 220 when animating the example avatars 108.

The example emotional response lookup table 212 of FIG. 2 stores one or more emotions (e.g., including, but not limited to harmony responses, aggression responses, tense responses, calm responses, and/or playful responses) in association with one or more features and/or characteristics (e.g., including, but not limited to tempo, note type, octave, note duration, pitch, etc.) of an audio track. In such examples, the emotion response lookup table 212 supports software queries such as emotion response queries received from the feature extractor 206. In such examples, the emotion response lookup table 212 receives and/or otherwise retrieves one or more characteristics and/or features (e.g., a tempo value (e.g., 60 beats per minute (BPM), 140 BPM, etc.), a note duration (e.g., quarter note, eighth note, 0.24 seconds, etc.), a pitch (e.g., C sharp, G, A flat, etc.), octave, etc.) from the feature extractor 206 and returns an emotion corresponding to the one or more features and/or characteristics to the feature extractor 206.

At least one of the example audio data storage 104, the example audio data storage 208, the example visual data storage 210, and/or the example emotional response lookup table 212 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The example audio data storage 104, the example audio data storage 208, the example visual data storage 210, and/or the example emotional response lookup table 212 may additionally or alternatively be implemented by one or more double data rate (DDR) memories, such as DDR, DDR2, DDR3, mobile DDR (mDDR), etc. The example audio data storage 104, the example audio data storage 208, the example visual data storage 210, and/or the example emotional response lookup table 212 may additionally or alternatively be implemented by one or more mass storage devices such as hard disk drive(s), compact disk drive(s), digital versatile disk drive(s), etc. While the illustrated example of FIGS. 1 and 2 illustrate the example audio data storage 104, the example audio data storage 208, the example visual data storage 210, and/or the example emotional response lookup table 212 as single databases, the example audio data storage 104, the example audio data storage 208, the example visual data storage 210, and/or the example emotional response lookup table 212 may be implemented by any number and/or type(s) of databases. Further, the example audio data storage 104, the example audio data storage 208, the example visual data storage 210, and/or the example emotional response lookup table 212 may be located in the example avatar response generator 100 or at a central location outside of the example avatar response generator 100. Furthermore, the data stored in the example audio data storage 104, the example audio data storage 208, the example visual data storage 210, and/or the example emotional response lookup table 212 may be in any data format such as, for example, binary data, comma delimited data, tab delimited data, structured query language (SQL) structures, etc.

The example user interface manager 214 of FIG. 2 processes interactions with the user interface 106 of FIG. 1. In some examples, processing interactions further include coordinating distribution of an input to the user interface 106 to a receiving structure (e.g., one or more of the audio data coder 204, the feature extractor 206, the audio data storage 208, the visual data storage 210, the emotional response lookup table 212, the user interface manager 214, the machine learning engine 216, and/or the avatar behavior controller 218, etc.). In some examples, in response to a user requesting data (e.g., MIDI message data, avatar status data, audio and/or video characteristic data, etc.) from the avatar response generator 100 be displayed on the user interface 106, the user interface manager 214 retrieves the data from the corresponding structure of the avatar response generator 100.

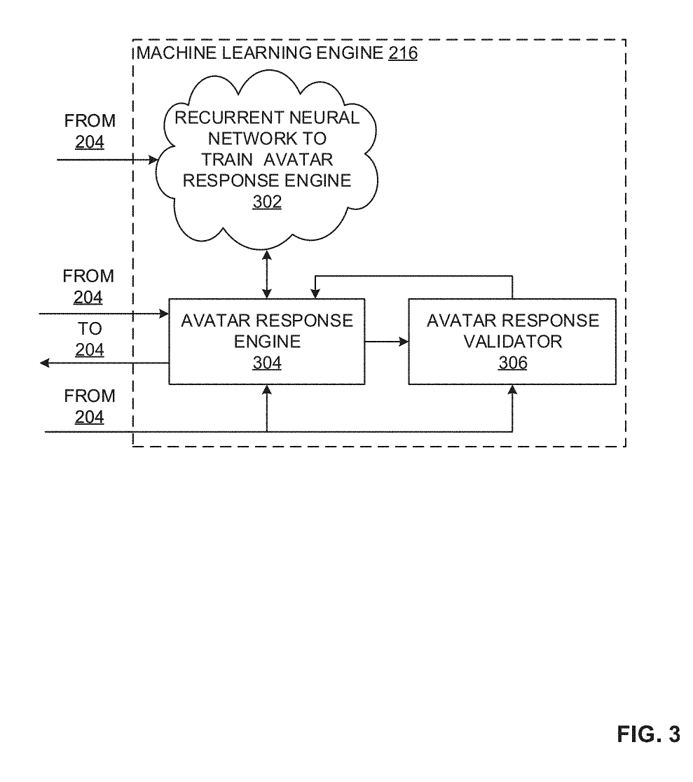

The example machine learning engine 216 of FIG. 2, further described in connection with FIG. 3, generates a model that determines an audio and/or visual response of the example avatars 108. In some examples, the model is generated based upon a two dimensional array of values derived from an input MIDI file representative of a musical phrase and utilizing machine learning techniques. In some examples, the machine learning engine 216 additionally implements the machine learned model and, in such examples, outputs a two dimensional array representative of a probability distribution of a plurality of tones being rendered to the audio data coder 204. The two dimensional array is further described in connection with FIG. 4B.

The example avatar behavior controller 218 of FIG. 2 includes at least one of the example biomechanical model engine 220, the example graphics engine 222, and the example audio engine 224. In some examples, the avatar behavior controller 218 converts at least a MIDI file received from the audio data coder 204 and one or more emotions of the avatars 108 associated with the audio track corresponding to the MIDI file into an audio and visual representation of the avatars 108. In some examples, the audiovisual representation of one of the avatars 108 is visually output on one of the displays 111 and auditorily output by one of the audio emitters 112.

The example biomechanical model engine 220 of FIG. 2 applies the emotion of at least one of the avatars 108 as determined by the feature extractor 206 (e.g., retrieved from the example emotional response lookup table 212) to the static 3D model of at least one of the avatars 108 stored in the visual data storage 210 as movement instructions. In some examples, this results in an animation corresponding to the emotion and the 3D model. By way of example, as illustrated by the example first avatar 108A of FIG. 1 and in response to a “calm response” emotion, the biomechanical model engine 220 can cause a swaying of the upper torso of the 3D model (e.g., as illustrated by the example first motion profile 114A). By way of yet another example, as illustrated by the example second avatar 108B of FIG. 1 and in response to an “aggressive response” emotion, the biomechanical model engine 220 can cause a vertical rocking of the head of the 3D model (e.g., as illustrated by the example second motion profile 114B). In either example, the biomechanical model engine 220 can generate the motion paths based upon one or more characteristics (e.g., joint locations, joint ranges, skeletal structure, etc.) of a respective biomechanical model associated with at least one of the avatars 108.

The example graphics engine 222 of FIG. 2 may be, by way of one example, the Unity® graphics engine. In some examples, the graphics engine 222 converts data representative of an animation of at least one of the avatars 108 retrieved from the biomechanical model engine 220 in conjunction with the 3D model of at least one of the avatars 108 to a visual representation/animation of the respective avatars 108 to be displayed by one of the displays 111. In such examples, the visual representation/amination can include a sequence of two dimensional arrays (the values stored in each array representative of one or more characteristics of a corresponding pixel) representative of a sequence of still images to be displayed as an animation (e.g., video) on the displays 111. Further in such examples, the graphics engine 222 can distribute the sequence of arrays to the displays 111 for further processing and display.

The example audio engine 224 of FIG. 2 converts a MIDI file output by the audio data coder 204 into a format processable by the audio emitters 112. For example, the audio engine 224 can convert the MIDI file into at least one of an .mp3, .WAV, .AAC, etc. file. Further in such examples, the audio engine 224 can distribute the audio file to the audio emitters 112 for further processing and display. In some examples, the graphics engine 222 and the audio engine 224 communicate the output of a data file to the opposing engine (e.g., the graphics engine 222 communicates output of a graphics file to the audio engine 224, the audio engine 224 communicates output of an audio file to the graphics engine 222, etc.) such that the output of the audio and video are substantially coordinated with one another.

FIG. 3 is a block diagram showing additional detail of the machine learning engine 216 of FIG. 2. The example machine learning engine 216 provides a trained model for use by at least one of the example feature extractor 206 and/or the example avatar behavior controller 218 of FIG. 2. Machine learning techniques, whether deep learning networks or other experiential/observational learning system, can be used to optimize results, locate an object in an image, understand speech and convert speech into text, and improve the relevance of search engine results, etc. While many machine learning systems are seeded with initial features and/or network weights to be modified through learning and updating of the machine learning network, a deep learning network trains itself to identify “good” features for analysis. Using a multilayered architecture, machines employing deep learning techniques can process raw data better than machines using conventional machine learning techniques. Examining data for groups of highly correlated values or distinctive themes is facilitated using different layers of evaluation or abstraction.

Machine learning techniques, whether neural networks, deep learning networks, and/or other experiential/observational learning system(s), can be used to generate optimal results, locate an object in an image, understand speech and convert speech into text, and improve the relevance of search engine results, for example. An example neural network can be trained on a set of expert classified data, for example. This set of data builds the first parameters for the neural network, and this would be the stage of supervised learning. During the stage of supervised learning, the neural network can be tested whether the desired behavior has been achieved.

Once a desired neural network behavior has been achieved (e.g., a machine has been trained to operate according to a specified threshold, etc.), the machine can be deployed for use (e.g., testing the machine with “real” data, etc.). During operation, neural network classifications can be confirmed or denied (e.g., by an expert user, expert system, reference database, etc.) to continue to improve neural network behavior. The example neural network is then in a state of transfer learning, as parameters for classification that determine neural network behavior are updated based on ongoing interactions. In some examples, the neural network such as an example neural network 302 of FIG. 3 provide direct feedback to another process, such as an example avatar response engine 304 (described further in connection with FIGS. 4A and 4B), etc. In certain examples, the neural network 302 outputs data that is buffered (e.g., via the cloud, etc.) and validated before it is provided to another process.

In the example of FIG. 3, the neural network 302 receives input from previous audio tracks (e.g., retrieved from a database, dynamically executed by a musician, an output of the learned model, etc.) that have been converted to the MIDI file format (e.g., a sequence of MIDI tones) and further encoded for use with machine learning techniques. In some examples, the neural network 302 outputs an algorithm to generate a probability distribution associated with the likelihood of the execution of one or more MIDI tones. In some examples, the probability distribution is further utilized to generate a sequence of MIDI tones different from the input sequence of MIDI tones by the audio data coder 204. The example network 302 can be seeded with some initial correlations and can then learn from ongoing experience and/or iterations. In some examples, the neural network 302 continually receives feedback from the audio data coder 204. In the illustrated example of FIG. 3, throughout the operational life of the machine learning engine 216, the neural network 302 is continuously trained via feedback and the example avatar response engine 304 is updated based on the neural network 302 and/or additional MIDI file based training data encoded by the audio data coder 204. The example network 302 learns and evolves based on role, location, situation, etc.

In some examples, a level of accuracy of the model generated by the neural network 302 is determined by an example avatar response validator 306. In such examples, at least one of the example avatar response engine 304 and the example avatar response validator 306 receive and/or otherwise retrieve a set of audio track validation data encoded for use by the machine learning engine 216 from, for example, the audio data storage 208 by way of the audio data coder 204 of FIG. 2. The example avatar response engine 304 receives inputs associated with the validation data and predicts one or more audio tracks associated with the inputs associated with the validation data. The predicted outcomes are distributed to the example avatar response validator 306. The example avatar response validator 306 additionally receives the known audio tracks associated with the validation data and compares the known audio tracks with the predicted audio tracks received from the example avatar response engine 304. In some examples, the comparison will yield a level of accuracy of the model generated by the example neural network 302 (e.g., if 95 comparisons yield a match and 5 yield an error, the model is 95% accurate, etc.). Once the example neural network 302 reaches a threshold level of accuracy (e.g., the example network 302 is trained and ready for deployment), the example avatar response validator 306 outputs the model to the example avatar response engine 304 for use in generating response audio tracks (e.g., the tracks different than the input tracks) in response to receiving an audio track not included in the training and/or validation dataset.

FIGS. 4A and 4B illustrate example auditory response generation data flows 400A, 400B through the avatar response generator 100. In the illustrated example of FIG. 4A, the auditory response generation data flow 400A illustrates an example call 402A, in which the example call 402A is a spatial representation of one or more tones (e.g., notes) included in a MIDI file. In the illustrated example of FIG. 4A, the one or more tones included in the MIDI file are represented by corresponding example markers 403. In some examples, a vertical position of the marker 403 with respect to the page corresponds to a pitch of the tone and a horizontal position of the marker 403 with respect to the page corresponds to a timing of the tone. In the illustrated example of FIG. 4A, each of the markers 403 are associated with a probability value (e.g., a probability the tone is played). However, because the tones included in the call 402A are defined by a predefined note sequence (e.g., the note sequence previously executed/played), the probability of each marker 403 is thus predefined. For example, each tone included in the call 402A (e.g., visually represented by markers 403) has a 100% chance of occurring (e.g., corresponding to a value of 1.0 on a scale of 0-1) and each tone not included in the call 402A (e.g., visually represented by blank space) has a 0% chance of occurring.

In some examples, the call 402A is passed to the avatar response engine 304 including one or more long short term memory (LSTM) cell(s) 404A-L to process the data associated with the markers 403, one or more limiters 406A-E to apply a limit to values generated by the LSTM cells 404A-L, and one or more biasers 408A-F to bias the values generated by the LSTM cells 404A-L by a known value and/or correlation. In the illustrated example, the LSTM cells 404A-L, in connection with the limiters 406A-E and the biasers 408A-F, process and/or otherwise predict time series information in connection with time lags of data having an irregular duration between events, such as the MIDI tones associated with the markers 403 included in the call 402A. In some examples, the output of the avatar response engine 304 is a probability distribution of a plurality of MIDI tones (e.g., a 30% chance a first MIDI tone is rendered, a 70% chance a second MIDI tone is rendered, etc.).

The output of the avatar response engine 304 is illustrated by a response 410A. In the illustrated example of FIG. 4A, the response 410A is a visual representation of a probability distribution indicating probabilities of one or more tones being included in a MIDI file representative of an audio track. In the illustrated example, the response 410A includes a plurality of possible notes visually represented by markers 411A-D, wherein vertical positions of the markers 411A-D with respect to the page correspond to a pitch of the possible tones and horizontal positions of the markers 411A-D with respect to the page correspond to a timing of the possible tones. Additionally, in the illustrated example of FIG. 4A, shading of the markers 411A-D is representative of a probability of the tone being included in the audio track. For example, deeper shadings of the markers 411A-D (e.g., the marker 411A being the least shaded and increasing to 411D being the most shaded) represent increasing probabilities that the tone is included in the audio track associated with the response 410A. In other examples, numeric probability values are embedded in the markers 411A-D. For example, in FIG. 4A, marker 411A is associated with a 10% probability value (e.g., indicated by a value of 0.1), marker 411B is associated with a 25% probability value (e.g., indicated by a value of 0.25), marker 411C is associated with a 75% probability value (e.g., indicated by a value of 0.75), and marker 411D is associated with a 90% probability value (e.g., indicated by a value of 0.9).

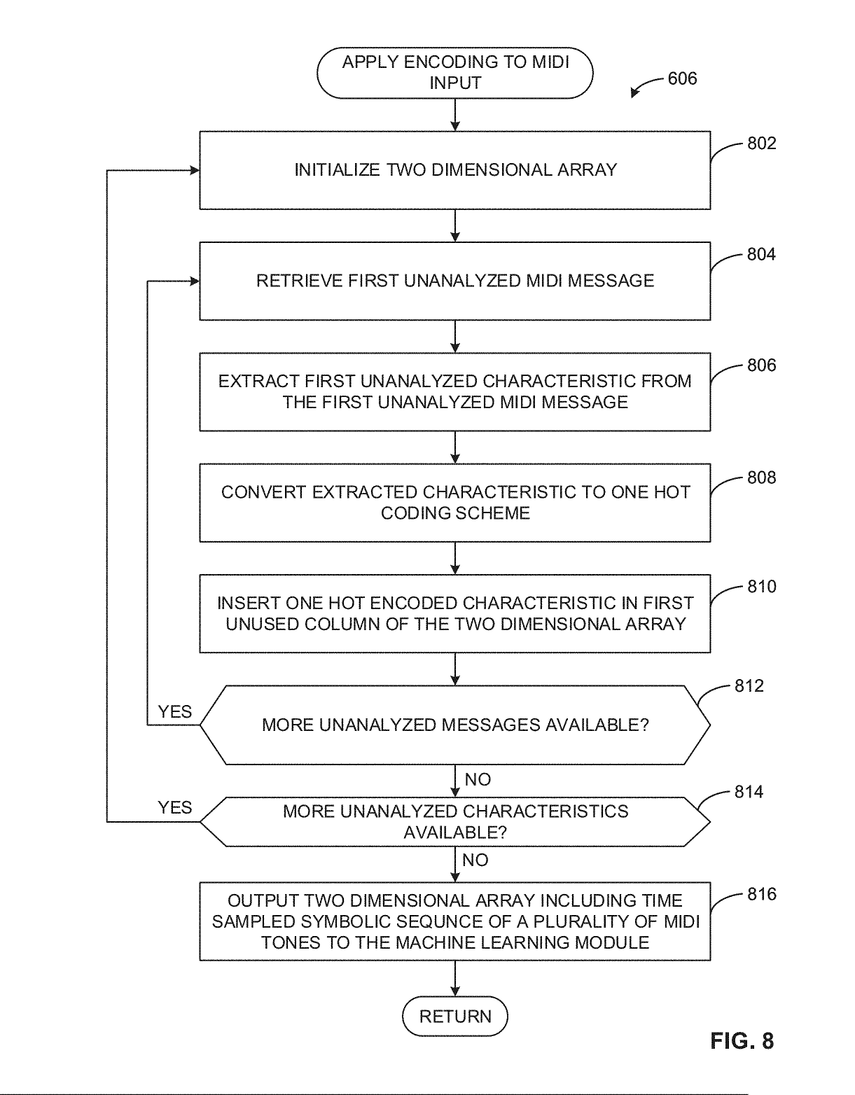

In FIG. 4B, auditory response generation data flow 400B is illustrated. In the illustrated example of FIG. 4B, the data flow 400B illustrates the data as previously presented in connection with the data flow 400A, but now illustrating the data as a two dimensional array 402B (e.g., corresponding to the call 402A) including a plurality of binary values as encoded (e.g., as represented by block 401) by the example audio data coder 204 of FIG. 2. The two dimensional array 402B, in the illustrated example, includes values either equal to “0” or “1” as the probability distribution is defined based upon a known sequence of tones (e.g., notes) in the call 402A and, thus, lends itself to the one hot encoding (e.g., wherein each column includes a singular “1” value (e.g., the “hot” value) and the remaining column values equal “0”) further described in conjunction with FIGS. 2 and 8.

The example two dimensional array 402B is passed to or otherwise retrieved by the example avatar response engine 304, again including at least one of each of the LSTM cell(s) 404A-L, the limiters 406A-E, and the biasers 408A-F, as described above. An example output 410B of the avatar response engine 304, in the illustrated example, is a two dimensional array (e.g., corresponding to the response 410A) including one or more probability distributions as output by the avatar response engine 304. In some examples, the probability distributions (wherein a plurality of tones are possible at each time throughout the tone sequence) enable an output MIDI file (e.g., an output tone sequence) to differ from the MIDI file input to the avatar response engine 304. As, in some examples, the avatar response generator 100 only considers which value in each column of the two dimensional array 410B is the largest, the example two dimensional array 410B (e.g., output) is not normalized in order to conserve computing resources and therefor can include values greater than 1 and/or less than 0.

An example audio data coder 412 uses an argument maximum (e.g., argmax, or similar) to generate a one dimensional array 414 having values associated with the index value of the largest probability value in each of the columns of the two dimensional matrix 410B. For example, in a first column of the array 410B, the largest probability value is 101.2 (in the 2^{nd} index) and, therefore, the first value in the array 414 is 2. This is repeated for each column of the array 410B. The example one dimensional array 414 is converted into a MIDI file by the example audio data coder 204 (e.g., represented by block 416) and is output from the example audio data coder 204 to the example communication manager 202. Thus, as shown above, the example audio data coder 204 utilizes one hot encoding techniques to facilitate the application of machine learning techniques to a first sequence of tones stored as first MIDI messages in a first MIDI file. Further, utilizing probability distributions output by the machine learning techniques, the avatar response generator 304 outputs a second MIDI file including a second sequence of notes that differs from the first sequence of notes, but retains one or more characteristics of the first sequence. For example, the second sequence of notes can include pitches that differ from the first sequence of notes, but retain an emotional response (e.g., harmony response, aggression response, etc.) of the first sequence of notes.

FIG. 5 illustrates an example user interface 500 by which a user (in some examples, one of the musicians 102 of FIG. 1) may interact with and/or control the example avatar response generator 100. In the illustrated example of FIG. 5, the user interface 500 includes several interactive controls including an example input control interface 502, an example output instrument selection interface 504, an example input instrument selection interface 506, an example avatar interaction interface 508, an example first avatar state interface 510, and an example second avatar state interface 512.

The example input control interface 502 of FIG. 5 allows the user to select whether the example avatar response generator 100 is recording the output of a MIDI instrument played by one of the musicians 102 or playing back a previously recorded output of the MIDI instrument. Additionally, a user can initialize an example metronome 514 defined by a volume, a speed (e.g., in beats per minute) and a repetition time defined by a quantity of bars and beats utilizing the input control interface 502. In the illustrated example of FIG. 5, the input control interface 502 is set to “Play” (e.g., the avatar response generator 100 is outputting a phrase previously played by one of the musicians 102).

The example output instrument selection interface 504 of FIG. 5 facilitates selection of an output instrument/avatar (e.g., the example first avatar 108A (playing bass guitar) and/or the example second avatar 108B (playing electric guitar)). In some examples, the output instrument selection interface 504 facilitates control over whether one of the avatars 108 is performing a solo and/or interacting with the other one of the avatars 108 and/or one of the musicians 102. In the illustrated example, the guitar output (e.g., the second avatar 108B) is set to perform an “Interact” function.

The example input instrument selection interface 506 of FIG. 5 facilitates selection of an input instrument/musician (e.g., the example first musician 102A (playing a MIDI drum set) and/or the example second musician 102B (playing a piano). In some examples, the input instrument selection interface 506 facilitates control over whether the output of the musicians 102 is distributed to one of the avatars 108 or both.

The example avatar interaction interface 508 of FIG. 5 facilitates control over the interaction between one or more of the musicians 102 and one or more of the avatars 108. Example interactions that can be set by the example avatar interaction interface 508 include, as illustrated in FIG. 5, one of the musicians 102 acting as the input to the example avatar response generator 100 and both of the avatars 108 receiving the output of the example avatar response generator 100. In other examples, an interaction between the example first avatar 108A acting as the input to the example avatar response generator 100 and the example second avatar 108B receiving the output of the example avatar response generator 100 may be set. Additionally, these examples are not meant to be limiting and many other example interactions can be set by the example avatar interaction interface 508.

The example first avatar state interface 510 and the example second avatar state interface 512 of FIG. 5 output a state of a first avatar (e.g., the example first avatar 108A of FIG. 1) and a second avatar (e.g., the example second avatar 108B of FIG. 1), respectively. In some examples such as the illustrated example of FIG. 5, the example first avatar 108A is playing a bass guitar and the example second avatar 108B is playing a guitar. However, the avatars 108 may be playing any instrument. Additionally, the example first and second avatar state interfaces 510, 512 illustrate five (5) potential states of the avatars 108: ready (e.g., the avatars 108 are ready and able to receive a musical (e.g., MIDI) input), listening (e.g., the avatars 108 are currently receiving a MIDI input from at least one the musicians 102 and/or the audio data storage 104), playing (e.g., the avatars 108 are outputting an audio and/or visual response based on a trained model), looping (e.g., the avatars 108 are repeating the audio and/or visual response based on the trained model), and evolving (e.g., the avatars 108 insert the current audio and/or visual output into the model to generate a second output different than the current output). In the illustrated example of FIG. 5, the example first avatar state interface 510 illustrates the state of the example first avatar 108A as “Ready” and the example second avatar state interface 512 illustrates the state of the example second avatar 108B as “Playing.”

While an example manner of implementing the avatar response generator 100 of FIG. 1 is illustrated in FIG. 2, one or more of the elements, processes and/or devices illustrated in FIG. 2 may be combined, divided, re-arranged, omitted, eliminated and/or implemented in any other way. Further, the example communication manager 202, the example audio data coder 204, the example feature extractor 206, the example user interface manager 214, the example machine learning engine 216 including at least one of the example neural network 302, the example avatar response engine 304, and/or the example avatar response validator 306, the example avatar behavior controller 218 including at least one of the example biomechanical model engine 220, the example graphics engine 222, and/or the example audio engine 224, and/or, more generally, the example avatar response generator 100 of FIG. 1 may be implemented by hardware, software, firmware and/or any combination of hardware, software and/or firmware. Thus, for example, any of the example communication manager 202, the example audio data coder 204, the example feature extractor 206, the example user interface manager 214, the example machine learning engine 216 including at least one of the example neural network 302, the example avatar response engine 304, and/or the example avatar response validator 306, the example avatar behavior controller 218 including at least one of the example biomechanical model engine 220, the example graphics engine 222, and/or the example audio engine 224, and/or, more generally, the example avatar response generator 100 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example communication manager 202, the example audio data coder 204, the example feature extractor 206, the example user interface manager 214, the example machine learning engine 216 including at least one of the example neural network 302, the example avatar response engine 304, and/or the example avatar response validator 306, and/or the example avatar behavior controller 218 including at least one of the example biomechanical model engine 220, the example graphics engine 222, and/or the example audio engine 224 is/are hereby expressly defined to include a non-transitory computer readable storage device or storage disk such as a memory, a digital versatile disk (DVD), a compact disk (CD), a Blu-ray disk, etc. including the software and/or firmware. Further still, the example avatar response generator 100 of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

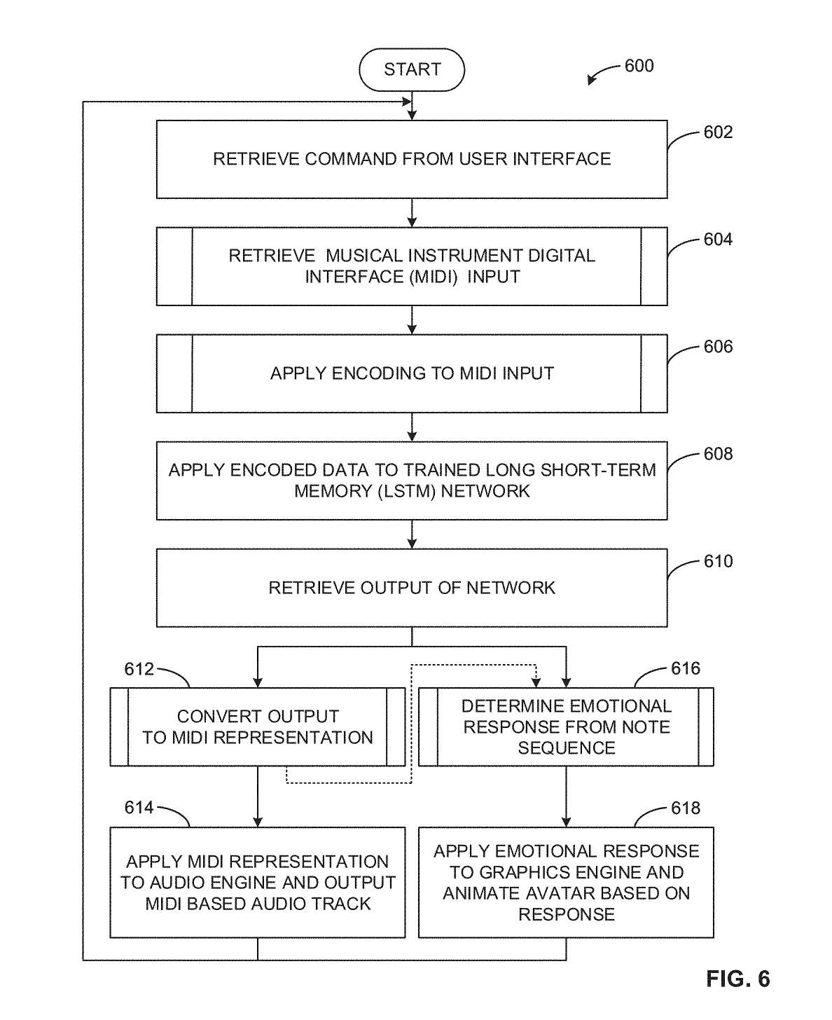

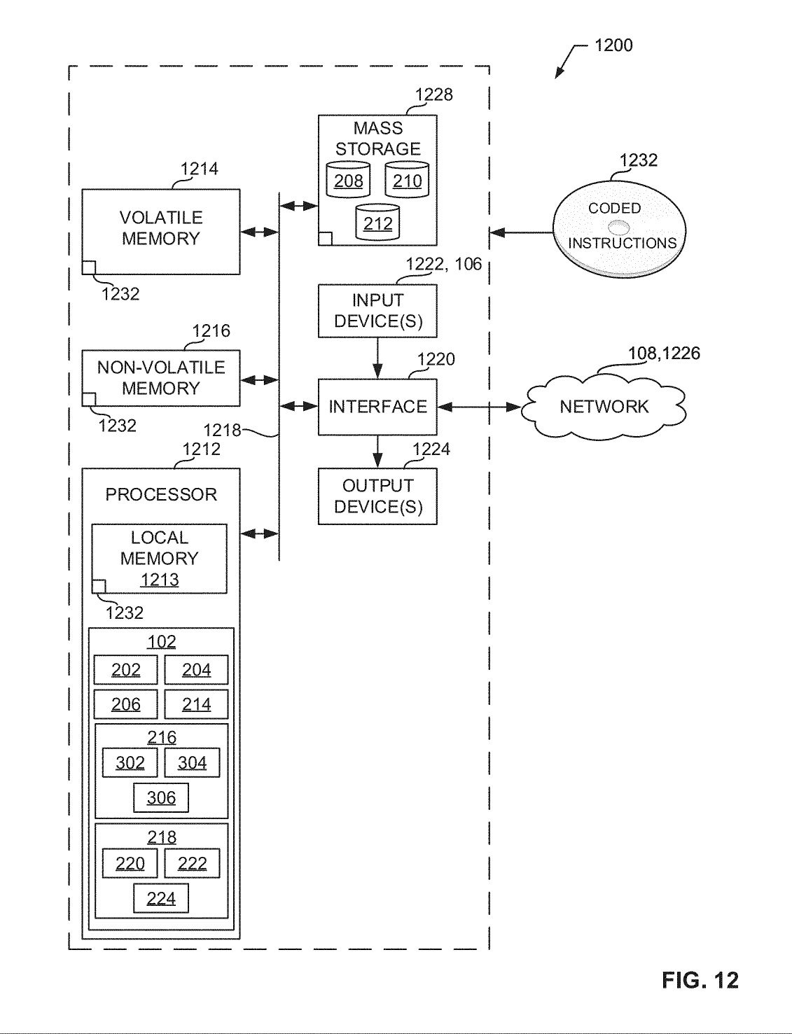

Flowcharts representative of example hardware logic, machine readable instructions, hardware implemented state machines, and/or any combination thereof for implementing the avatar response generator 100 of FIG. 1 are shown in FIGS. 6-11. The machine readable instructions may be an executable program or portion of an executable program for execution by a computer processor such as the processor 1212 shown in the example processor platform 1200 discussed below in connection with FIG. 12. The program may be embodied in software stored on a non-transitory computer readable storage medium such as a CD-ROM, a floppy disk, a hard drive, a DVD, a Blu-ray disk, or a memory associated with the processor 1212, but the entire program and/or parts thereof could alternatively be executed by a device other than the processor 1212 and/or embodied in firmware or dedicated hardware. Further, although the example programs are described with reference to the flowcharts illustrated in FIGS. 6-11, many other methods of implementing the example avatar response generator 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIGS. 6-11 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C.

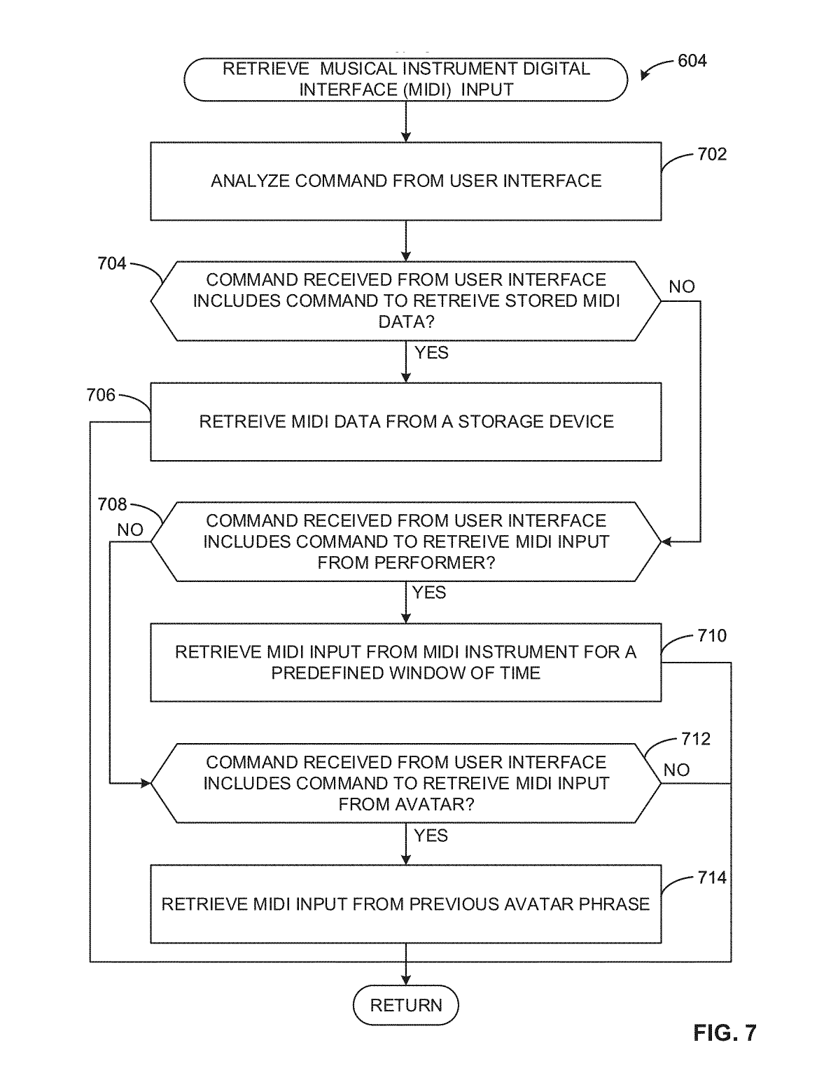

The program 600 of FIG. 6 begins when the example user interface manager 214 retrieves a command from a user interface (e.g., the example user interface 500) via the example communication manager 202 (block 602). In response to retrieval of an input command, the communication manager 202 retrieves musical instrument digital interface (MIDI) data (block 604). The example communication manager 202 retrieves the MIDI data from at least one of the example musicians, the example avatars 108, and/or the example audio data storage(s) 104, 208 based on an analysis of the command received from the example user interface 500 completed by the example user interface manager 214. This example process (block 604) is further described in connection with FIG. 7.

The example audio data coder 204 applies an encoding scheme to the MIDI data (block 606). In some examples, applying the encoding scheme to the MIDI data (block 606) further includes organizing the MIDI data in a two dimensional array, such as the example two dimensional array 402B of FIG. 4B, as described below in connection with FIG. 8. In some examples, the two dimensional array 402B includes a plurality of values representative of certain tones being rendered at certain times.

In response to completion of the encoding process (block 606), the example audio data coder 204 passes the two dimensional array representative of the plurality of MIDI tones to the example avatar response engine 304 of FIG. 3 (block 608). In some examples, the avatar response engine 304 applies a long short-term memory (LSTM) network to the two dimensional array, the output of which is a second (e.g., modeled array) two dimensional array of probability values (e.g., one or more probability distributions associated with one or more tones to be rendered), such as the example two dimensional array 410B of FIG. 4B. In some examples, the avatar response engine 304 is to determine the greatest probability value in each column of the two dimensional array and an index value associated with the greatest probability value using the example argmax function 412 of FIG. 4B (block 608) (e.g., generating the example one dimensional array of values 414).

The example audio data coder 204 retrieves the output of the LSTM network implemented by the example avatar response engine 304 (block 610). In some examples, the output includes the two dimensional array 410B and the example audio data coder 204 completes additional post processing on the values to generate an example one dimensional array of values (block 610) (e.g., such as the example one dimensional array of values 414). In other examples, the output includes the example one dimensional array of values 414 (e.g., each value representing the index value associated with the greatest probability value in the respective column). In response to the retrieval of the output by the audio data coder 204 (block 610), processing proceeds to block 612 and block 616.

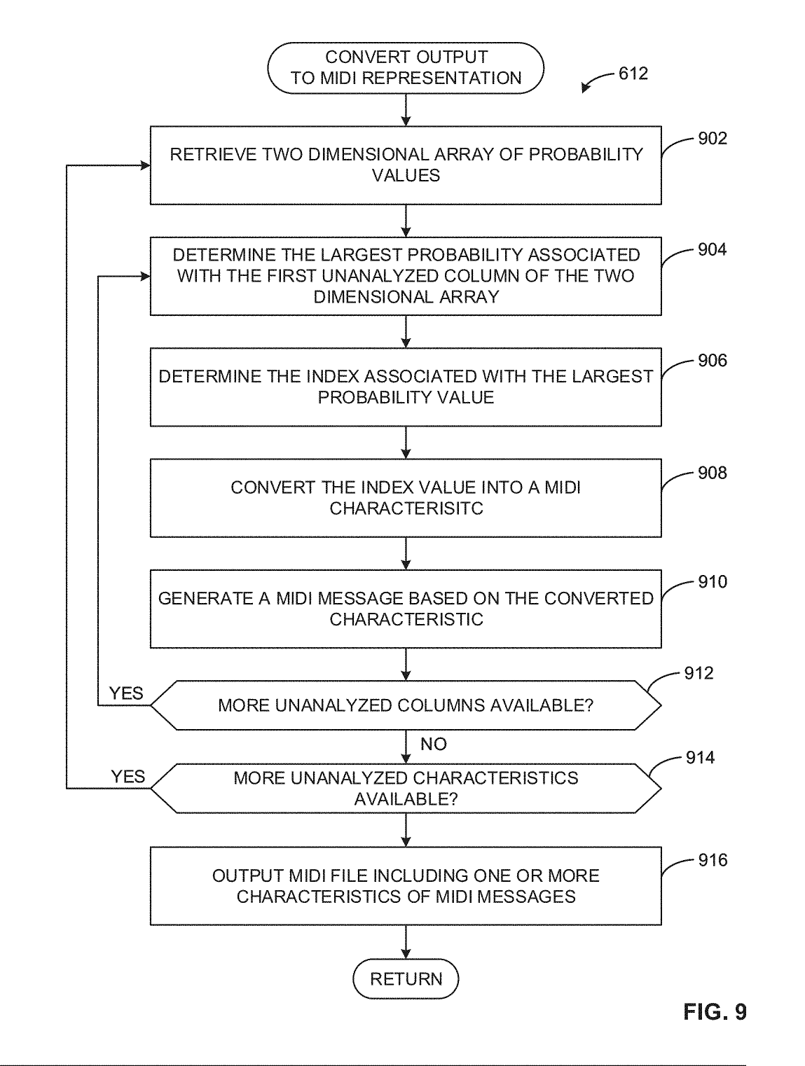

The example audio data coder 204 converts at least one of the example two dimensional array 410B and/or the example one dimensional array of values 414 into a MIDI file (block 612). This process is further described in connection with FIG. 9.

The example audio engine 224 outputs the MIDI based audio track to be rendered (e.g., played back) by one of the example avatars 108 to the example audio emitters 112 (block 614). In some examples, the audio track is rendered substantially coordinated with an animation to be rendered by the corresponding one of the example avatars 108 (described further in connection with block 618 below). In response to the execution of the audio track by the example audio emitters 112 (block 614), the example communication manager 202 retrieves a command from the example user interface 500 (block 602).

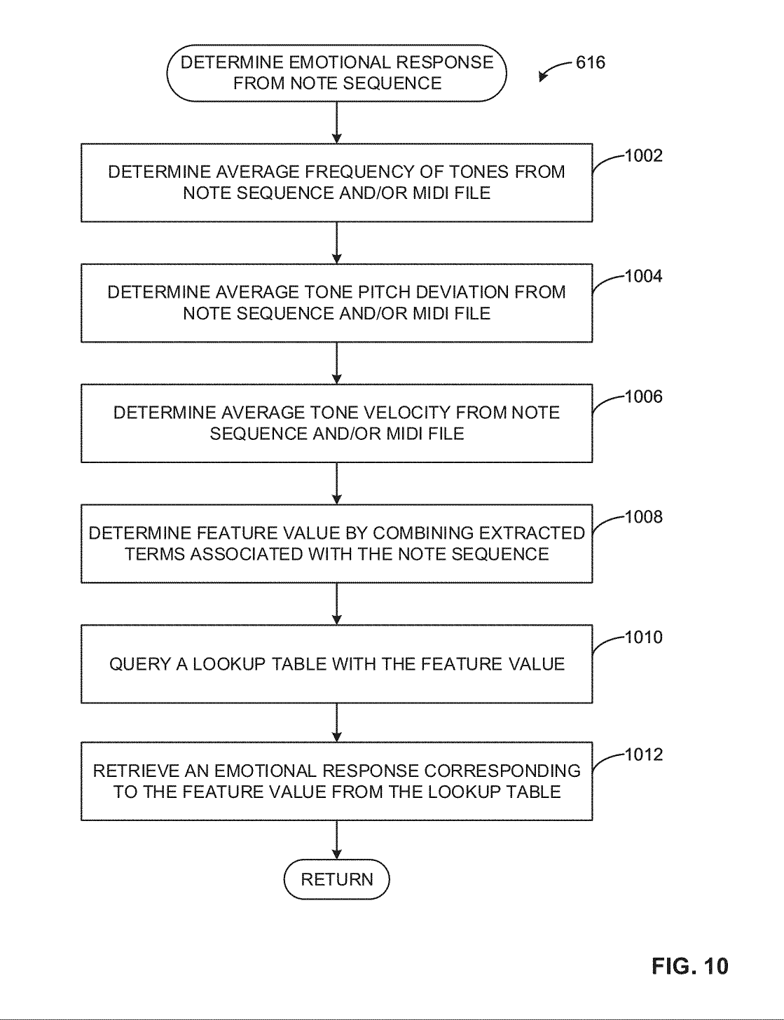

The example feature extractor 206 determines an emotional response to be displayed by at least one of the example avatars 108 based on one or more features and/or characteristics of the note sequence retrieved by the feature extractor 206 (block 616). In other examples, the feature extractor 206 can instead determine the emotional response based upon the MIDI file generated. This process is further described in connection with FIG. 10.

The example graphics engine 222 outputs the animation (e.g., video, graphics, etc.) associated with the MIDI based audio track to be rendered (e.g., played back) by one of the example avatars 108 to the example displays 111 (block 618). In some examples, the animation is rendered substantially coordinated with the MIDI based audio track to be rendered by the corresponding one of the avatars 108 (described further in connection with block 614). In response to the execution of the animation by the example displays 111 (block 618), the example communication manager 202 retrieves a command from the example user interface 500 (block 602).

Additional detail in connection with retrieving a musical instrument digital interface (MIDI) input (FIG. 6, block 604) is shown in FIG. 7. FIG. 7 is a flowchart representative of an example method that can be performed by the example avatar response generator 100 of FIG. 2. The example method begins when the example user interface manager 214 included in the example avatar response generator 100 analyzes a command received from a user interface (e.g., the example user interface 500 of FIG. 5) to determine a retrieval location of the MIDI input (block 702).

The example user interface manager 214 determines, based on the analysis of the command (block 702), whether the command received from the example user interface 500 indicates that the MIDI input is to be retrieved from stored data (e.g., audio data stored in at least one of the example audio data storage(s) 104, 208) (block 704). In response to determining the command received from the example user interface 500 indicates the MIDI input is to be retrieved from stored data, the communication manager 202 retrieves the corresponding MIDI input data from at least one of the example audio data storage(s) 104, 208 (block 706) and the example audio data coder 204 applies an encoding scheme to the MIDI input (block 606 of the example program 600 of FIG. 6).

Conversely, in response to determining the command received from the example user interface 500 indicates the MIDI input is not to be retrieved from stored data, the example user interface manager 214 determines whether the command received from the user interface 500 indicates that the MIDI input is to be retrieved from MIDI data associated with a performer (e.g., at least one of the example musicians 102) (block 708). In response to determining the command received from the example user interface 500 indicates the MIDI input is to be retrieved from one of the example musicians 102, the example communication manager 202 listens for (e.g., retrieves) MIDI input data from one of the musicians 102 (block 710). In some examples, the MIDI input data corresponds to one or more tones executed by one of the example musician(s) 102 on respective MIDI instruments (the example first musician 102A playing a MIDI drum set and the example second musician 102B playing a MIDI piano in the illustrated example of FIG. 1) over a predefined window of time. In response to the completion of the window of time, the example audio data coder 204 applies an encoding scheme to the data (block 606 of the example program 600 of FIG. 6).

Conversely, in response to determining the command received from the example user interface 500 indicates the MIDI input is not to be retrieved from one of the example musicians 102, the example user interface manager 214 determines whether the command received from the example user interface 500 indicates that the MIDI input is to be retrieved from MIDI data associated with a prior output phrase of one of the avatars 108 (block 712).

In response to determining the command received from the example user interface 500 indicates the MIDI input is to be retrieved from the prior output phrase of one of the example avatars 108, the example communication manager 202 retrieves MIDI input data from one of the example avatars 108 (block 714). In some examples, the MIDI input data corresponds to one or more tones executed by one of the avatars 108 on respective virtual MIDI instruments (the example first avatar 108A playing a virtual bass guitar and the example second avatar 108B playing a virtual guitar in the illustrated example of FIG. 1), and, in response to the retrieval of the MIDI data, the example audio data coder 204 applies an encoding scheme to the data (block 606 of the example program 600 of FIG. 6). Conversely, in response to determining the command received from the example user interface 500 indicates the MIDI input is not to be retrieved from one of the avatars 108, no MIDI data is retrieved by the example communication manager 202.

Additional detail in connection with applying encoding to a MIDI file (FIG. 6, block 606) is shown in FIG. 8. FIG. 8 is a flowchart representative of an example method that can be performed by the example audio data coder 204 of FIG. 2. The example method begins when the example audio data coder 204 initializes a two dimensional array (e.g., in some examples, the example two dimensional array 402B) (block 802). In some examples, a quantity of columns in the initialized array is equal to a number of MIDI messages included in the MIDI file.

In response to the initialization of the array, the example audio data coder 204 retrieves the first unanalyzed MIDI message (e.g., visually represented by the example marker 403 of FIG. 4A) from the MIDI file (block 804). In some examples, the MIDI message is associated with at least one of a start, a hold, and/or an end of a MIDI tone. Utilizing the retrieved MIDI tone, the audio data coder 204 extracts a first unanalyzed characteristic such as a pitch, channel, or velocity (e.g., volume) from the MIDI message (block 806). In some examples, the pitch, channel, and velocity values are stored as at least one of a numeric value (e.g., a characteristic value including a value between 0-127, each value corresponding to a distinct note and octave, a distinct audio channel, or distinct velocity (e.g., volume) level) or a hexadecimal value.

In response to extracting a value corresponding to a characteristic from the MIDI message, the extracted characteristic is converted by the example audio data coder 204 utilizing a one hot coding scheme (block 808). As used herein, a “one hot coding” (OHC) scheme is a scheme where a one dimensional array of values includes a single binary “1” value, the remaining values corresponding to binary “0” values. To convert the characteristic using one hot encoding, the example audio data coder 204 inserts the “1” value in the one dimensional array of values at a location (e.g., an index) corresponding to the numeric value of the characteristic. Thus, for an example where the encoded characteristic is a pitch value (e.g., wherein the characteristic could additionally or alternatively be channel, volume, etc.), if the numeric value corresponding to a pitch of the MIDI tone is equal to 7 (e.g., G in the 0^{th} octave), the OHC scheme will generate a one dimensional array with a “1” in the 7^{th} position of the array and zeroes in the remaining positions.

In response to generating the one dimensional array, the example audio data coder 204 inserts the one dimensional array generated at into the first unused column of the two dimensional array (block 810). In response to the insertion of the one dimensional array, the example audio data coder 204 determines whether any MIDI messages have yet to be analyzed (block 812). In response to determining one or more MIDI messages are yet to be analyzed, the example audio data coder 204 retrieves the first unanalyzed MIDI message (block 804). Conversely, in response to determining all MIDI messages of the given MIDI file are analyzed, the audio data coder 204 determines whether any characteristics (e.g., pitch, velocity, duration, etc.) of the MIDI messages are not yet analyzed (block 814). In response to determining one or more characteristics are not yet analyzed, the audio data encoder 204 initializes an empty two dimensional array (block 802). In response to determining all characteristics are analyzed, the example audio data coder 204 outputs the one or more two dimensional matrices to the machine learning engine 216 (block 816) and the example machine learning engine 216 applies the one or more two dimensional matrices to the avatar response engine 304 (block 608 of the example program 600 of FIG. 6).

Additional detail in connection with converting an output of the of the trained neural network model (FIG. 6, block 612) is shown in FIG. 9. FIG. 9 is a flowchart representative of an example method that can be performed by the example audio data coder 204 of FIG. 2. The example method begins when the example audio data coder 204 retrieves a two dimensional array of probability values from the example machine learning engine 216 (block 902). In response to the retrieval of the array, the example audio data coder 204 determines the largest probability associated with the first unanalyzed column of the two dimensional array (block 904). For example, if the first unanalyzed column of the array includes [85.4, 23.8, −4.5, 6.7, 104.6, 98.4], the audio data coder 204 determines that 104.6 is the largest data in the column.

The audio data coder 204 further determines the index (e.g., position) of the largest probability value associated with the first unanalyzed column (block 906). Thus, using the example above wherein 104.6 is the largest value, the largest probability value is in the 5^{th} index/position of the column.

The audio data coder 204 converts the index value into a MIDI characteristic (block 908). In some examples, this includes a direct translation of the index value (e.g., 5^{th} index value, in the given example) to a MIDI value (e.g., a value of 5 (corresponding to, for pitch, an F in the 0^{th} octave as retrieved from an example lookup table), in the given example). In other examples, the MIDI value can be determined based on a mathematical correlation of the index value to the MIDI value.

In either case, the audio data coder 204 generates a MIDI message (e.g., a visual representation of which is illustrated by the example marker 403 of FIG. 4A) based on the MIDI value determined (block 910). In some examples, generating a MIDI message further includes determining whether the characteristic determined is associated with at least one of a start of a tone, a hold tone, an end of a tone, etc.

In response to the generation of the MIDI message, the example audio data coder 204 determines whether the two dimensional array of probability values includes any unanalyzed columns (block 912). In response to one or more of the columns being unanalyzed, the example audio data coder 204 determines the largest probability associated with the first unanalyzed column of the two dimensional array (block 904). Conversely, in response to all columns of the two dimensional array having been analyzed, determines whether any two dimensional arrays of probability values (e.g., each two dimensional array associated with a characteristic type (e.g., pitch, channel, velocity, etc.)) are not yet analyzed (block 914). In response to determining one or more characteristics are not yet analyzed, the audio data encoder retrieves an unanalyzed two dimensional array of probability values (block 902). In response to determining all characteristics are analyzed, the example audio data coder 204 outputs a MIDI file including the one or more generated MIDI messages, each including one or more characteristics (block 916). Upon output of the MIDI file, the example audio engine 224 outputs the MIDI file as an audio track to the audio emitters 112 (block 614 of the example program 600 of FIG. 6).

Additional detail in connection with determining an emotional response of one of the avatars 108 based on one or more features and/or characteristics of a note sequence output by the example avatar response engine 304 (FIG. 6, block 616) is shown in FIG. 10. FIG. 10 is a flowchart representative of an example method that can be performed by the example feature extractor 206 of FIG. 2. The example method begins when the feature extractor 206 determines an average frequency of notes in the note sequence and/or MIDI file (block 1002). In some examples, the note frequency value is calculated based on a quantity of notes in the sequence divided by a total time of the sequence.

In response to completion of the calculation of note frequency, the feature extractor 206 determines an average pitch deviation from the note sequence and/or MIDI file (block 1004). In some examples, the average pitch deviation value is calculated based on a deviation value associated with each adjacent pair of notes (e.g., tones). For example, if a first tone in the adjacent pair is defined by a pitch of C and the second tone in the adjacent pair is defined by a pitch of D, the deviation value between the two is equal to one. In a second example, if the first tone in the adjacent pair is defined by a pitch of B and the second tone in the adjacent pair is defined by a pitch of E, the deviation value between the two is equal to three.

In response to determining an average pitch deviation based upon each adjacent pair of tones in the note sequence and/or MIDI file, the feature extractor 206 determines an average tone velocity (e.g., the velocity associated with a volume/intensity of the tone) from the note sequence and/or MIDI file (block 1006). In some examples, the average tone velocity is calculated based on velocity values (e.g., discrete values ranging from 1-128, 1 being lowest intensity and 128 being maximum intensity). In some examples, the average is calculated by summing the discrete value associated with each tone and dividing by the quantity of tones in the note sequence.

In response to determining the average velocity value for the tones included in the note sequence and/or MIDI file, the feature extractor 206 determines a feature value based on the previously determined values of frequency of tones, average pitch deviation of tones, and average velocity of tones (block 1008). In some examples, the feature value calculated by the feature extractor 206 is a one dimensional vector including each of the previously determined values. In other examples, the feature value calculated by the feature extractor 206 is determined based upon a mathematical correlation to which the previously determined values are input.

In either example, in response to determining the feature value, the feature extractor 206 queries the example emotional response lookup table 212 of FIG. 2, wherein the query includes the feature value calculated (block 1010). The example emotional response lookup table 212, utilizing the feature value, determines one or more emotions (e.g., including, but not limited to harmony responses, aggression responses, tense responses, calm responses, and/or playful responses) based upon the feature value, wherein the one or more emotions are stored in association with the corresponding feature values in the example emotional response lookup table 212. In response to determining the one or more emotions, the example emotional response lookup table 212 returns the emotions to the example feature extractor 206, which applies the emotions to the example graphics engine 222 (block 618 of the example program 600 of FIG. 6).

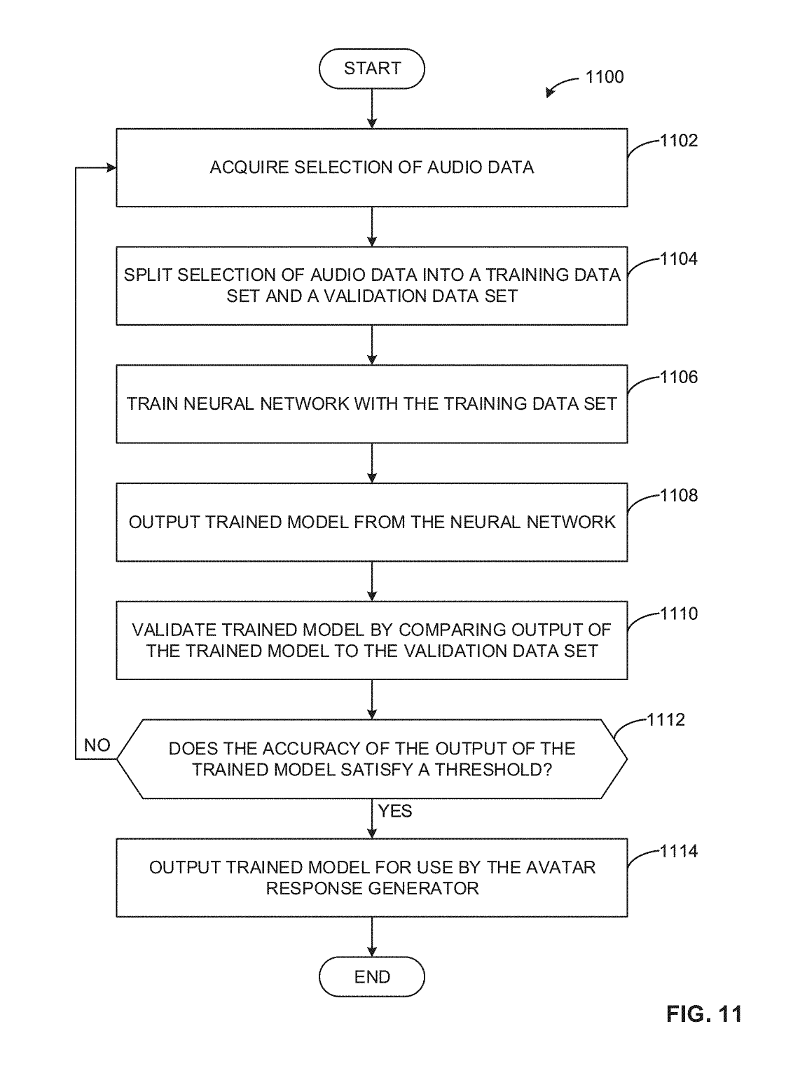

An example program 1100 for training the example neural network 302 of FIG. 3, the training completed utilizing one or more audio tracks, is illustrated in FIG. 11. The example program 1100 begins when the example machine learning engine 216 acquires data representative of a selection of audio tracks (block 1102). In some examples, the data acquired by the example machine learning engine 216 includes one or more two dimensional arrays (e.g., such as the example two dimensional array 402B) generated by the example audio data coder 204. In such examples, the two dimensional arrays are representative of MIDI files that are further representative of audio tracks retrieved from, for example, the example audio data storage 208.

In response to the acquisition of data, the example machine learning engine 216 divides the data representative of audio tracks into two data sets including a training data set and a validation data set (block 1104). In some examples, the training data set includes a substantially larger portion of the data (e.g., approximately 95% of the data, in some examples) than the validation data set (e.g., approximately 5% of the data, in some examples). The example machine learning engine 216, in response to splitting of the data sets, distributes the training data to at least the example neural network 302 and the validation data to at least the example avatar response engine 304 and the example avatar response validator 306.

In response to the distribution of the data sets, the example neural network 302 trains a model based on the training data (block 1106). This process is described in further detail in connection with FIG. 3. In some examples, the trained model is capable of generating a second note sequence based on a first note sequence input to the model, the second note sequence different from the first note sequence.

Once the training of the model is complete, the trained model is output to the example avatar response engine 304 (block 1108) and the example avatar response validator 306 compares one or more output of the trained model executing at the avatar response engine 304 to one or more known outputs included in the validation data set (block 1110). Based on the comparison, the example avatar response validator 306 determines a quantity of correct outputs of the trained model and a quantity of incorrect outputs of the trained model.

In response to the determination of the quantity of correct/incorrect outputs, the example avatar response validator 306 determines an accuracy of the trained model based upon the quantity of correct outputs and incorrect outputs of the trained model executing at the example avatar response engine 304 (block 1112).

In response to the accuracy of the validation output of the model not satisfying the threshold (e.g., is less than the threshold), the example machine learning engine 216 acquires data representative of a selection of audio tracks (block 1102). Alternatively, in response to the accuracy of a validation output of the model (e.g., 82%, 89%, 95%, etc.) satisfying a threshold (e.g., is greater than the threshold), the example avatar response validator 306 instructs the example avatar response engine 304 to utilize the current trained model to determine one or more outputs of the avatars 108 based on note sequences received from one or more structures included in the example avatar response generator 100 (block 1114). In response to the initialization of the trained model, the program 1100 of FIG. 11 ends.

FIG. 12 is a block diagram of an example processor platform 1200 structured to execute the instructions of FIGS. 6-11 to implement the avatar response generator 100 of FIG. 1. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example communication manager 202, the example audio data coder 204, the example feature extractor 206, the example user interface manager 214, the example machine learning engine 216 including at least one of the example neural network 302, the example avatar response engine 304, and/or the example avatar response validator 306, the example avatar behavior controller 218 including at least one of the example biomechanical model engine 220, the example graphics engine 222, and/or the example audio engine 224, and/or, more generally, the example avatar response generator 100.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), a Bluetooth® interface, a near field communication (NFC) interface, and/or a PCI express interface.

In the illustrated example, one or more input devices 1222 are connected to the interface circuit 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1220 of the illustrated example, thus, typically includes a graphics driver card, a graphics driver chip and/or a graphics driver processor.

The interface circuit 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1226. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, redundant array of independent disks (RAID) systems, and digital versatile disk (DVD) drives. In some examples such as the illustrated example of FIG. 12, the mass storage 1228 implements at least one of the audio data storage 208, the visual data storage 210, and/or the emotional response lookup table 212.

The machine executable instructions 1232 of FIGS. 6-11 may be stored in the mass storage device 1228, in the volatile memory 1214, in the non-volatile memory 1216, and/or on a removable non-transitory computer readable storage medium such as a CD or DVD.

From the foregoing, it will be appreciated that example methods, apparatus and articles of manufacture have been disclosed that generate an audiovisual response of an avatar utilizing machine learning techniques based on one or more musical phrases input to a machine learned model. Thus, by analyzing the musical phrases with machine learning techniques, the computing device promotes accuracy of the audiovisual output of the avatar as well as real time analysis of musical phrases and output of an audiovisual response of the avatar. In some examples, the musical phrase input is in a format incompatible with machine learning techniques and the output of the machine learned model is incompatible for output as an audiovisual response of the avatar. Examples disclosed herein further include converting the musical phrase input to a format compatible with machine learning techniques and converting the output of the machine learned model to a format compatible for output as an audiovisual response of the avatar. Thus, examples disclosed herein enable the use of machine learning techniques in analyzing and/or generating musical phrases (e.g., audio responses).

Example 1 includes an apparatus to control an avatar, the apparatus comprising an audio data coder to convert a first digital signal representative of first audio including a first tone, the first digital signal incompatible with a model, to a plurality of binary values representative of a first characteristic value of the first tone, the plurality of binary values compatible with the model, and select one of a plurality of characteristic values associated with a plurality of probability values output from the model, the plurality of probability values incompatible for output via a second digital signal representative of second audio, as a second characteristic value associated with a second tone to be included in the second audio, the second characteristic value compatible for output via the second digital signal, and an avatar behavior controller to generate an audiovisual response of the avatar based on the second digital signal and a first response type.

Example 2 includes the apparatus of example 1, wherein the audio data coder is to format the first audio as a first two dimensional array, a column of the first two dimensional array including the plurality of binary values, the plurality of binary values representative of the first characteristic value.

Example 3 includes the apparatus of example 2, wherein the plurality of values included in the column includes a plurality of zero value bits and an individual one value bit, an index of the one value bit indicative of the first characteristic value of the first tone.

Example 4 includes the apparatus of example 2, further including a machine learning engine to generate the model.

Example 5 includes the apparatus of example 4, wherein the machine learning engine is to output the second audio as a second two dimensional array, a column of the second two dimensional array including the plurality of probability values associated with the plurality of characteristic values of the second tone, the plurality of probability values including a probability value associated with the second characteristic value.

Example 6 includes the apparatus of example 5, wherein the audio data coder is to select the second characteristic value when the probability value of the second characteristic value is greater than the plurality of probabilities associated with the plurality of characteristic values.

Example 7 includes the apparatus of example 1, further including a communication manager to retrieve the first digital signal as a musical instrument digital interface (midi) file from at least one of a storage device, a musical instrument in communication with the audio data coder, or a prior audio response of the avatar.

Example 8 includes the apparatus of example 1, further including a feature extractor to determine features associated with the second characteristic value, the features associated with the first response type of the avatar, a biomechanical model engine to convert the first response type into movement instructions of the avatar, and a graphics engine to cause the avatar to be animated based on the first response type and the movement instructions of the avatar.

Example 9 includes the apparatus of example 1, wherein the first and second characteristic values include at least one of a channel, a pitch, a duration, or a velocity associated with the first and second tones, respectively.

Example 10 includes a method to present an avatar, the method comprising converting, by executing an instruction with at least one processor, a first digital signal representative of first audio including a first tone, the first digital signal incompatible with a model, to a plurality of binary values representative of a first characteristic value of the first tone, the plurality of binary values compatible with the model, selecting, by executing an instruction with the at least one processor, one of a plurality of characteristic values associated with a plurality of probability values output from the model, the plurality of probability values incompatible for output via a second digital signal representative of second audio, as a second characteristic value associated with a second tone to be included in the second audio, the second characteristic value compatible for output via the second digital signal, and controlling, by executing an instruction with the at least one processor, the avatar to output an audiovisual response based on the second digital signal and a first response type.

Example 11 includes the method of example 10, further including formatting the first audio as a first two dimensional array, a column of the first two dimensional array including the plurality of binary values, the plurality of binary values representative of the first characteristic value.

Example 12 includes the method of example 11, wherein the plurality of values included in the column includes a plurality of zero value bits and an individual one value bit, an index of the one value bit indicative of the first characteristic value of the first tone.

Example 13 includes the method of example 11, further including generating the model with a machine learning engine.

Example 14 includes the method of example 11, further including outputting the second audio as a second two dimensional array, a column of the second two dimensional array including the plurality of probability values associated with the plurality of characteristic values of the second tone, the plurality of probability values including a probability value associated with the second characteristic value.

Example 15 includes the method of example 14, further including selecting the second characteristic value when the probability value of the second characteristic value is greater than the plurality of probabilities associated with the plurality of characteristic values.

Example 16 includes the method of example 10, further including retrieving the first digital signal as a musical instrument digital interface (midi) file from at least one of a storage device, a musical instrument, or a prior audio response of the avatar.

Example 17 includes the method of example 10, further including determining features associated with the second characteristic value, the features associated with the first response type of the avatar, converting the first response type into movement instructions of the avatar, and animating the avatar based on the first response type and the movement instructions of the avatar.

Example 18 includes the method of example 10, wherein the first and second characteristic values include at least one of a channel, a pitch, a duration, or a velocity associated with the first and second tones, respectively.

Example 19 includes a non-transitory computer-readable storage medium comprising instructions that, when executed, cause a machine to, at least convert a first digital signal representative of first audio including a first tone, the first digital signal incompatible with a model, to a plurality of binary values representative of a first characteristic value of the first tone, the plurality of binary values compatible with the model, select one of a plurality of characteristic values associated with a plurality of probability values output from the model, the plurality of probability values incompatible for output via a second digital signal representative of second audio, as a second characteristic value associated with a second tone to be included in the second audio, the second characteristic value compatible for output via the second digital signal, and generate an audiovisual response of an avatar based on the second digital signal and a first response type.

Example 20 includes the non-transitory computer-readable storage medium of example 19, wherein the instructions, when executed, cause the machine to format the first audio as a first two dimensional array, a column of the first two dimensional array including the plurality of binary values, the plurality of binary values representative of the first characteristic value.

Example 21 includes the non-transitory computer-readable storage medium of example 20, wherein the plurality of values included in the column includes a plurality of zero value bits and an individual one value bit, an index of the one value bit indicative of the first characteristic value of the first tone.

Example 22 includes the non-transitory computer-readable storage medium of example 20, wherein the instructions, when executed, cause the machine to generate the model by executing a machine learning engine.

Example 23 includes the non-transitory computer-readable storage medium of example 20, wherein the instructions, when executed, cause the machine to output the second audio as a second two dimensional array, a column of the second two dimensional array including the plurality of probability values associated with the plurality of characteristic values of the second tone, the plurality of probability values including a probability value associated with the second characteristic value.

Example 24 includes the non-transitory computer-readable storage medium of example 23, wherein the instructions, when executed, cause the machine to select the second characteristic value when the probability value of the second characteristic value is greater than the plurality of probabilities associated with the plurality of characteristic values.

Example 25 includes the non-transitory computer-readable storage medium of example 19, wherein the instructions, when executed, cause the machine to retrieve the first digital signal as a musical instrument digital interface (midi) file retrieved from at least one of a storage device, a musical instrument, or a prior audio response of the avatar.

Example 26 includes the non-transitory computer-readable storage medium of example 19, wherein the instructions, when executed, cause the machine to determine features associated with the second characteristic value, the features associated with the first response type of the avatar, convert the first response type into movement instructions of the avatar, and animate the avatar based on the first response type and the movement instructions of the avatar.

Example 27 includes the non-transitory computer-readable storage medium of example 19, wherein the first and second characteristic values include at least one of a channel, a pitch, a duration, or a velocity associated with the first and second tones, respectively.

Example 28 includes a system to generate a behavior of an avatar, the system comprising means for coding audio data, the means for coding audio data to convert a first digital signal representative of first audio including a first tone, the first digital signal incompatible with a model, to a plurality of binary values representative of a first characteristic value of the first tone, the plurality of binary values compatible with the model, and select one of a plurality of characteristic values associated with a plurality of probability values output from the model, the plurality of probability values incompatible for output via a second digital signal representative of second audio, as a second characteristic value associated with a second tone to be included in the second audio, the second characteristic value compatible for output via the second digital signal, and means for controlling an avatar to output an audiovisual response based on the second digital signal and a first response type.

Example 29 includes the system of example 28, wherein the coding audio data means is to format the first audio as a first two dimensional array, a column of the first two dimensional array including the plurality of binary values, the plurality of binary values representative of the first characteristic value.

Example 30 includes the system of example 29, wherein the plurality of values included in the column includes a plurality of zero value bits and an individual one value bit, an index of the one value bit indicative of the first characteristic value of the first tone.

Example 31 includes the system of example 29, further including means for generating the model.

Example 32 includes the system of example 31, wherein the model generating means is to output the second audio as a second two dimensional array, a column of the second two dimensional array including the plurality of probability values associated with the plurality of characteristic values of the second tone, the plurality of probability values including a probability value associated with the second characteristic value.

Example 33 includes the system of example 32, wherein the coding audio data means is to select the second characteristic value when the probability value of the second characteristic value is greater than the plurality of probabilities associated with the plurality of characteristic values.

Example 34 includes the system of example 28, further including a means for retrieving the first digital signal as a musical instrument digital interface (midi) file from at least one of a storage device, a musical instrument, or a prior audio response of the avatar.

Example 35 includes the system of example 28, further including means for determining features associated with the second characteristic value, the features associated with the first response type of the avatar, means for converting the first response type into movement instructions of the avatar, and means for causing the avatar to be animated based on the first response type and the movement instructions of the avatar.

Example 36 includes the system of example 28, wherein the first and second characteristic values include at least one of a channel, a pitch, a duration, or a velocity associated with the first and second tones, respectively.

It is noted that this patent claims priority from U.S. Provisional Patent Application No. 62/614,477, filed Jan. 7, 2018, entitled “Methods, Systems, Articles of Manufacture and Apparatus to Generate Emotional Response for a Virtual Avatar.”

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus to control an avatar, the apparatus comprising:
an audio data coder to:
convert a first digital signal representative of first audio including a first tone, the first digital signal incompatible with a model, to a plurality of binary values representative of a first characteristic value of the first tone, the plurality of binary values compatible with the model; and
select one of a plurality of characteristic values associated with a plurality of probability values output from the model, the plurality of probability values incompatible for output via a second digital signal representative of second audio, as a second characteristic value associated with a second tone to be included in the second audio, the second characteristic value compatible for output via the second digital signal; and
an avatar behavior controller to generate an audiovisual response of the avatar based on the second digital signal and a first response type.

2. The apparatus of claim 1, wherein the audio data coder is to format the first audio as a first two dimensional array, a column of the first two dimensional array including the plurality of binary values, the plurality of binary values representative of the first characteristic value.

3. The apparatus of claim 2, wherein the plurality of values included in the column includes a plurality of zero value bits and an individual one value bit, an index of the one value bit indicative of the first characteristic value of the first tone.

4. The apparatus of claim 2, further including a machine learning engine to generate the model.

5. The apparatus of claim 4, wherein the machine learning engine is to output the second audio as a second two dimensional array, a column of the second two dimensional array including the plurality of probability values associated with the plurality of characteristic values of the second tone, the plurality of probability values including a probability value associated with the second characteristic value.

6. The apparatus of claim 5, wherein the audio data coder is to select the second characteristic value when the probability value of the second characteristic value is greater than the plurality of probabilities associated with the plurality of characteristic values.

7. The apparatus of claim 1, further including a communication manager to retrieve the first digital signal as a Musical Instrument Digital Interface (MIDI) file from at least one of a storage device, a musical instrument in communication with the audio data coder, or a prior audio response of the avatar.

8. The apparatus of claim 1, further including:
a feature extractor to determine features associated with the second characteristic value, the features associated with the first response type of the avatar;
a biomechanical model engine to convert the first response type into movement instructions of the avatar; and
a graphics engine to cause the avatar to be animated based on the first response type and the movement instructions of the avatar.

9. The apparatus of claim 1, wherein the first and second characteristic values include at least one of a channel, a pitch, a duration, or a velocity associated with the first and second tones, respectively.

10. A method to present an avatar, the method comprising:
converting, by executing an instruction with at least one processor, a first digital signal representative of first audio including a first tone, the first digital signal incompatible with a model, to a plurality of binary values representative of a first characteristic value of the first tone, the plurality of binary values compatible with the model;
selecting, by executing an instruction with the at least one processor, one of a plurality of characteristic values associated with a plurality of probability values output from the model, the plurality of probability values incompatible for output via a second digital signal representative of second audio, as a second characteristic value associated with a second tone to be included in the second audio, the second characteristic value compatible for output via the second digital signal; and
controlling, by executing an instruction with the at least one processor, the avatar to output an audiovisual response based on the second digital signal and a first response type.

11. The method of claim 10, further including formatting the first audio as a first two dimensional array, a column of the first two dimensional array including the plurality of binary values, the plurality of binary values representative of the first characteristic value.

12. The method of claim 11, wherein the plurality of values included in the column includes a plurality of zero value bits and an individual one value bit, an index of the one value bit indicative of the first characteristic value of the first tone.

13. The method of claim 11, further including generating the model with a machine learning engine.

14. The method of claim 11, further including outputting the second audio as a second two dimensional array, a column of the second two dimensional array including the plurality of probability values associated with the plurality of characteristic values of the second tone, the plurality of probability values including a probability value associated with the second characteristic value.

15. The method of claim 14, further including selecting the second characteristic value when the probability value of the second characteristic value is greater than the plurality of probabilities associated with the plurality of characteristic values.

16. (canceled)

17. The method of claim 10, further including:
determining features associated with the second characteristic value, the features associated with the first response type of the avatar;
converting the first response type into movement instructions of the avatar; and
animating the avatar based on the first response type and the movement instructions of the avatar.

18. (canceled)

19. A non-transitory computer-readable storage medium comprising instructions that, when executed, cause a machine to, at least:
convert a first digital signal representative of first audio including a first tone, the first digital signal incompatible with a model, to a plurality of binary values representative of a first characteristic value of the first tone, the plurality of binary values compatible with the model;
select one of a plurality of characteristic values associated with a plurality of probability values output from the model, the plurality of probability values incompatible for output via a second digital signal representative of second audio, as a second characteristic value associated with a second tone to be included in the second audio, the second characteristic value compatible for output via the second digital signal; and
generate an audiovisual response of an avatar based on the second digital signal and a first response type.

20. The non-transitory computer-readable storage medium of claim 19, wherein the instructions, when executed, cause the machine to format the first audio as a first two dimensional array, a column of the first two dimensional array including the plurality of binary values, the plurality of binary values representative of the first characteristic value.

21. The non-transitory computer-readable storage medium of claim 20, wherein the plurality of values included in the column includes a plurality of zero value bits and an individual one value bit, an index of the one value bit indicative of the first characteristic value of the first tone.

22. The non-transitory computer-readable storage medium of claim 20, wherein the instructions, when executed, cause the machine to generate the model by executing a machine learning engine.

23. The non-transitory computer-readable storage medium of claim 20, wherein the instructions, when executed, cause the machine to output the second audio as a second two dimensional array, a column of the second two dimensional array including the plurality of probability values associated with the plurality of characteristic values of the second tone, the plurality of probability values including a probability value associated with the second characteristic value.

24. The non-transitory computer-readable storage medium of claim 23, wherein the instructions, when executed, cause the machine to select the second characteristic value when the probability value of the second characteristic value is greater than the plurality of probabilities associated with the plurality of characteristic values.

25. The non-transitory computer-readable storage medium of claim 19, wherein the instructions, when executed, cause the machine to retrieve the first digital signal as a Musical Instrument Digital Interface (MIDI) file retrieved from at least one of a storage device, a musical instrument, or a prior audio response of the avatar.

26. The non-transitory computer-readable storage medium of claim 19, wherein the instructions, when executed, cause the machine to determine features associated with the second characteristic value, the features associated with the first response type of the avatar;
convert the first response type into movement instructions of the avatar; and
animate the avatar based on the first response type and the movement instructions of the avatar.

27. The non-transitory computer-readable storage medium of claim 19, wherein the first and second characteristic values include at least one of a channel, a pitch, a duration, or a velocity associated with the first and second tones, respectively.

28. (canceled)

29. (canceled)

30. (canceled)

31. (canceled)

32. (canceled)

33. (canceled)

34. (canceled)

35. (canceled)

36. (canceled)
